(19) United States
(12) Patent Application Publication
(10) Pub. No.: US 2022/0058681 A1
(43) Pub. Date: Feb. 24, 2022

(54) Credit Card Curator

(71) Applicant: Credit Card Curator, LLC, Lakeville, CT (US)

(72) Inventors: John Taylor Garner, Lakeville, CT (US); Bruce Gordon Garner, Lakeville, CT (US)

(21) Appl. No.: 16/996,574

(22) Filed: Aug. 18, 2020

(51) Int. Cl. G06Q 30/02; G06Q 30/06

(52) U.S. Cl. CPC G06Q 30/0232; G06Q 30/0631; G06Q 30/0236; G06Q 30/0239

(57) ABSTRACT

Various embodiments describe approaches for maximizing rewards associated with financial accounts for at least one user-defined goal (e.g., a travel benefit, a cashback benefit, a flight benefit, a hotel benefit, a charitable contribution benefit, a return benefit, etc.) For example, a user may submit a request for a portfolio of accounts (e.g., credit card accounts, checking accounts, savings accounts, a combination thereof) to achieve specific goals within a specified time given the user's spending habits, the number of credit card accounts desired, etc. Financial transaction information, reward program terms, banking institution policies, and the like can be obtained and analyzed to determine and present the portfolio of accounts, timing guidelines, and spending guidelines can be generated. Thereafter, rewards earned from purchases of goods and/or services made in accordance with the timing and spending guidelines maximize the rewards earned towards the user's goal for the specified period of time.

### BACKGROUND

Credit card rewards, such as airline frequent flyer miles, hotel points, general use points, cash rebates, and other benefits, are often offered to consumers in an effort to entice the consumer to enroll for a credit card account and/or to use a credit card for a purchase transaction. Generally, credit card providers earn fees for each transaction that a consumer makes with his or her credit card, which (the fees and/or the transactions) can be sizeable over the lifetime value of a consumer. As such, competition for consumer attention in this space is fierce—and has gotten more competitive with the advent of alternative digital payment systems such as digital wallets, which have tended to increase customer lifetime value, as well as cryptocurrencies, which represents an alternative or a threat to the traditional credit card transaction fees model. In an effort to remain competitive and relevant, credit card providers offer larger reward incentives with various reward structures (e.g., greater rewards for purchases for specific merchant categories, such as categories associated with travel or restaurants, greater rewards for using rewards with certain merchant or merchant categories, varying exchange rates for trading one reward for another, bonus rewards for spending a specified amount within a set period of time, etc.). All of this has made it much more complicated for a consumer to optimize for earning rewards and spending the rewards that they may have accumulated.

There are some optimization systems that help a consumer select a credit card for use from the credit cards that are already in their wallet. These systems try to categorize the merchant that may be associated with a potential transaction and suggest a credit card, from the cards in the consumer's wallet, that may offer the greatest number of reward points for spending associated with a merchant or a merchant category. Other optimization systems identify and suggest rewards that a consumer has already accumulated that can be applied towards a transaction. However, these systems often overlook the largest pool of rewards that are typically offered by credit card providers—sign-up bonuses that are offered for enrolling with a credit card account. As such, consumers who use currently available optimization system miss out on significant rewards that they may be eligible to receive. Moreover, because these optimization systems are geared towards maximizing the accumulation or the redemption of rewards in a vacuum (or, in other words, within the context of a particular transaction), they often miss out on benefits that could be accrued by exchanging one type reward point for another in a rewards marketplace. These systems also fail to optimize for or recommend rewards that may be more valuable to the consumer than others. Because of these limitations, current reward optimization systems offer limited utility and value to the consumer.

### SUMMARY

Systems and methods in accordance with various embodiments describe real-time or near real-time systems and methods for maximizing the accumulation, exchange, and/or redemption of credit card rewards for using and/or exchanging the rewards for a specific purpose, such as achieving a complex and dynamically changing goal.

For example, at a high level, a user may submit goals data (hereinafter also referred to as user defined goals), wherein the goal is complex and dynamically changing goal, such as a trip to Paris for two, for five days, with business class airplane travel, and five-star accommodation, wherein the entire trip is paid by rewards points. The systems and methods described herein analyze the goals data, identify one or more ways to accomplish that goal, identify rewards points that may be necessary to pay for the one or more ways to accomplish the goal, analyze the user's historic spending data and accumulated rewards data, apply an optimization algorithm to identify an efficient and realistic way for the user to apply, transfer and accumulate the necessary rewards to accomplish the goal, and recommend steps that the user can take to do so.

A variety of additional information and data points may be considered, as will be apparent in some of the subsequent sections, such as a time frame within which the user would like to accomplish the goal, the number of new credit card accounts the user wishes to sign-up for, the credit card accounts that the user is eligible for, the terms of the rewards associated with the one or more credit card accounts that the user can sign-up for, including, enrollment bonuses, spending requirements set forth by the credit card account rewards policies (for example, spending a preset amount within a preset time period to be eligible for enrollment bonuses), etc.

In an embodiment, the financial transaction information, the reward program terms for the plurality of reward programs, and banking institution policies for corresponding credit card accounts can be analyzed to generate selection scores for the credit card accounts. A selection score, in an embodiment, quantifies a degree to which rewards earned through the use of a corresponding credit card account maximizes the user goal. The selection scores in various embodiments includes a vector of scores. The selection scores can be used to determine a portfolio of accounts (e.g., credit card accounts, checking accounts, saving accounts, etc.) In an embodiment, the accounts can be new accounts or a combination of new and current accounts. Once the portfolio of accounts is determined or along with determining the portfolio, timing guidelines and spending guidelines can be generated. In an embodiment, the timing guidelines correspond to an order in which to use individual accounts to purchase goods and/or services. In an embodiment, the spending guidelines correspond to an amount to spend using the individual accounts to maximize the number of bonus points that can be earned based on the banking institution policies and reward program terms associated with the accounts.

The portfolio of accounts, the timing guidelines, or the spending guidelines can be presented to the user. In certain embodiments, an automated card application process applies for each of the cards in the portfolio. Thereafter, rewards earned from purchases of goods and/or services made in accordance with the timing and spending guidelines maximize the rewards earned towards the user's goal for the specified period of time.

Embodiments provide a variety of advantages. For example, in accordance with various embodiments, real-time accumulation, exchange, and/or redemption of credit card rewards can be utilized by any system that attempts to optimize resources including computing system resources. The systems can include, for example, banking services, financial services, travel services, hotel services, flight services, and other electronic environments that allow a user to exchange reward points and other currency for products and services. In accordance with various embodiments, by providing a system that in real-time maximizes reward points across various credit cards, the system can more efficiently and quickly facilitate financial transactions, account creation, and other transactions. For example, financial transactions in accordance with approaches described herein are optimized for various digital payment systems, and thus more likely efficiently make use of computing system resources. Further, the amount of time, computing and other such resources used to earn rewards and spend the rewards they may have been accumulated can be decreased. Further still, resources and user preferences can be reasonably balanced in an expedient manner, which can reduce cost, system resources, and time in earning rewards, which based on conventional approaches may otherwise lead to a lengthy process requiring additional expenses, waste, and ultimately result in user's missing out on the largest pool of rewards that are typically offered by credit card providers—sign-up bonuses that are offered for enrolling with a credit card account. As such, conventional systems are less efficient and fail to effectively utilize resources, which results in a suboptimal distribution of resources.

Various other functions and advantages are described and suggested below as may be provided in accordance with the various embodiments.

This summary is provided to introduce a selection of concepts in a simplified form that are further described below in the Detailed Description. This summary is not meant or intended to identify or exclude key features or essential features of the claimed subject matter, nor is it intended to be used as an aid in determining the scope of the claimed subject matter.

In one aspect, embodiments relate to a computing system that includes a computing device processor; and memory including instructions that, when executed by the computing device processor, enable the computing system to: receive a request by a consumer for a recommendation for at least one credit card account from a plurality of credit card accounts that maximize a reward criterion within a period of time; obtain financial transaction information associated with the consumer, the financial transaction information including one of purchase transaction information from financial accounts associated with the consumer or reward points associated with reward programs associated with the consumer; obtain reward program terms for a plurality of reward programs, individual reward programs associated with a credit card account, individual reward program terms specifying at least a reward program bonus and an amount to spend within a time period to receive the reward program bonus, individual credit card accounts associated with banking institution policies that specify eligibility requirements for qualifying for a corresponding credit card account; analyze the financial transaction information, the reward program terms for the plurality of reward programs, and banking institution policies for corresponding credit card accounts to generate selection scores for the credit card accounts, a selection score quantifying a degree to which rewards earned through use of a corresponding credit card account maximizes the reward criterion; determine a portfolio of new credit card accounts from the plurality of credit card accounts to be used for one or more categories of transactions based on the selection scores, individual credit card accounts in the portfolio satisfying the reward criterion within the period of time; determine timing guidelines corresponding to an order in which to use individual credit card accounts in the portfolio of credit card accounts and spending guidelines corresponding to an amount to spend using the individual credit card accounts to maximize at an amount of bonus points; and present at least one of the portfolio of credit card accounts, the timing guidelines, or the spending guidelines.

In some embodiments, the system is further enabled to analyze the purchase transaction information to determine categories for anticipated purchases; and generate a list of preferred credit card accounts for use during the period of time based on the categories for the anticipated purchases.

In some embodiments, the system is further enabled to analyze the purchase transaction information to classify individual purchase transactions in at least one category of transaction.

In some embodiments, the selection scores are further based on consumer preferences, the consumer preferences including at least one of a preferred airline, a preferred hotel, airline travel class, tier of hotel, desired destination, duration of stay, or number of travelers.

In some embodiments, the reward criterion is associated with one of a travel benefit, a cashback benefit, a flight benefit, a hotel benefit, a charitable contribution benefit, or return benefit.

In some embodiments, the portfolio of credit card accounts includes a combination of current credit card accounts and the new credit card accounts.

In some embodiments, the system is further enabled to determine a geographic location of the consumer; identify a business at which a financial transaction is being undertaken based on the geographic location; and identify a credit card account that maximizes the reward criterion when used to complete the financial transaction.

In some embodiments, the banking institution policies specifies an allowable number of new credit card accounts for a particular period of time.

In some embodiments, the reward points convert to one of a cash value or a number of miles, and wherein the selection scores is further based on a conversion ratio of reward points to the cash value.

In some embodiments, a number of credit card accounts in the portfolio is based on a user-provided number of credit card accounts.

In some embodiments, the system is further enabled to determine a geographic location of the consumer; identify a business at which a financial transaction is being undertaken based on the geographic location; and identify a credit card account that maximizes the reward criterion when used to complete the financial transaction.

In some embodiments the banking institution policies specifies an allowable number of new credit card accounts for a particular period of time.

In some embodiments the selection score is represented as a vector of scores, a vector corresponding to a credit card account, individual scores for the vector corresponding to one of the one or more categories of transactions.

In some embodiments, the system is further enabled to receive details of a financial transaction; and identify a credit card account that maximizes the reward criterion when used to complete the financial transaction.

In another aspect, embodiments relate to a method of receiving a request by a consumer for a recommendation for at least one credit card account from a plurality of credit card accounts that maximize a reward criterion within a period of time; obtaining financial transaction information associated with the consumer, the financial transaction information including one of purchase transaction information from financial accounts associated with the consumer or reward points associated with reward programs associated with the consumer; obtaining reward program terms for a plurality of reward programs, individual reward programs associated with a credit card account, individual reward program terms specifying at least a reward program bonus and an amount to spend within a time period to receive the reward program bonus, individual credit card accounts associated with banking institution policies that specify eligibility requirements for qualifying for a corresponding credit card account; analyzing the financial transaction information, the reward program terms for the plurality of reward programs, and banking institution policies for corresponding credit card accounts to generate selection scores for the credit card accounts, a selection score quantifying a degree to which rewards earned through use of a corresponding credit card account maximizes the reward criterion; determining a portfolio of new credit card accounts from the plurality of credit card accounts to be used for one or more categories of transactions based on the selection scores, individual credit card accounts in the portfolio satisfying the reward criterion within the period of time; determining timing guidelines corresponding to an order in which to use individual credit card accounts in the portfolio of credit card accounts and spending guidelines corresponding to an amount to spend using the individual credit card accounts to maximize at an amount of bonus points; and presenting at least one of the portfolio of credit card accounts, the timing guidelines, or the spending guidelines.

In some embodiments, the method further includes obtaining consumer preferences, the consumer preferences including at least one of a preferred airline, a preferred hotel, airline travel class, tier of hotel, desired destination, duration of stay, or number of travelers; and generating the selection scores based in part on the consumer preferences.

In some embodiments, the method further includes analyzing the financial transaction information to determine anticipated financial transactions; and generating a list of preferred credit card accounts for use during the period of time based on the anticipated financial transactions that maximize the reward criterion.

In yet another aspect, embodiments relate to a non-transitory computer readable storage medium storing one or more sequences of instructions executable by one or more processors to perform a set of operations comprising receiving a request by a consumer for a recommendation for at least one credit card account from a plurality of credit card accounts that maximize a reward criterion within a period of time; obtaining financial transaction information associated with the consumer, the financial transaction information including one of purchase transaction information from financial accounts associated with the consumer or reward points associated with reward programs associated with the consumer; obtaining reward program terms for a plurality of reward programs, individual reward programs associated with a credit card account, individual reward program terms specifying at least a reward program bonus and an amount to spend within a time period to receive the reward program bonus, individual credit card accounts associated with banking institution policies that specify eligibility requirements for qualifying for a corresponding credit card account; analyzing the financial transaction information, the reward program terms for the plurality of reward programs, and banking institution policies for corresponding credit card accounts to generate selection scores for the credit card accounts, a selection score quantifying a degree to which rewards earned through use of a corresponding credit card account maximizes the reward criterion; determining a portfolio of new credit card accounts from the plurality of credit card accounts to be used for one or more categories of transactions based on the selection scores, individual credit card accounts in the portfolio satisfying the reward criterion within the period of time; determining timing guidelines corresponding to an order in which to use individual credit card accounts in the portfolio of credit card accounts and spending guidelines corresponding to an amount to spend using the individual credit card accounts to maximize at an amount of bonus points; and presenting at least one of the portfolio of credit card accounts, the timing guidelines, or the spending guidelines.

In some embodiments, the financial transaction information further includes banking institution policies that specify one of a limit on a number of new credit card accounts for a period of time, an income minimum for the new credit card accounts, a minimum credit score for the new credit card accounts, or welcome bonus eligibility, and wherein the reward program terms include information relating to categories of transactions earning rewards that maximize the reward criterion.

In some embodiments, a purchase transaction information includes a plurality of financial transactions for the purchase of one of goods or services.

In some embodiments, individual purchases are associated with at least one purchase category, and wherein the financial transaction information is obtained from financial accounts associated with the consumer, and wherein the financial accounts include one of credit card accounts, checking accounts, savings accounts, or cash accounts.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates a user attempting to make a purchase in accordance with various embodiments.

FIG. 1B illustrates an example system for maximizing the accumulation, exchange, and/or redemption of credit card rewards for using and/or exchanging the rewards for a specific purpose, such as achieving a complex and dynamically changing goal in accordance with various embodiments.

FIG. 1C illustrates an example portfolio of accounts that can be utilized in accordance with various embodiments.

FIG. 2 illustrates an example approach to earning rewards from purchases made in accordance with timing and spending guidelines in accordance with various embodiments.

FIG. 3 illustrates an example interface that can be utilized in accordance with various embodiments.

FIG. 4A illustrates an example environment in which aspects of the various embodiments can be implemented in accordance with various embodiments.

FIG. 4B illustrates example components for generating a portfolio of credit card accounts in accordance with various embodiments.

FIG. 5A illustrates an example process for generating a portfolio of credit card accounts in accordance with various embodiments.

FIG. 5B illustrates an example process for providing real-time spending recommendations in accordance with various embodiments.

FIG. 6A a front view of an example device that can be used in accordance with various embodiments.

FIG. 6B illustrates a back view of an example device that can be used in accordance with various embodiments.

FIG. 7 illustrates a set of basic components of an electronic computing device in accordance with various embodiments.

FIG. 8 illustrates an example of an environment for implementing aspects in accordance with various embodiments.

### DETAILED DESCRIPTION

Various other functions and advantages are described and suggested below as may be provided in accordance with the various embodiments. Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The figures described herein generally illustrate an example approach to generating a portfolio of accounts that can be utilized in accordance with various embodiments. It should be understood that reference numbers are carried over between figures for similar components for purposes of simplicity of explanation, but such usage should not be construed as a limitation on the various embodiments unless otherwise stated. It should be further noted that the portfolio of accounts can include credit card accounts, checking accounts, savings accounts, investment accounts, digital currency accounts, and the like. Reference to a portfolio of credit card accounts is merely an example, and embodiments described herein apply to any combination of accounts, including credit card accounts, checking accounts, savings accounts, investment accounts, and the like. Further, a physical card may be linked to an individual account. For example, a credit card may be linked to a credit card account, a debit card may be linked to a checking account, etc. A card can be used to make purchases, obtain cash, make deposits, view account balances, transfer funds, etc. The term “credit card rewards” is used generally herein and throughout the specification for convenience but may more generally refer to rewards associated with using a financial instrument or for enrolling for an account that facilitates financial transaction, including, but not limited to (for example, a travel benefit, a cashback benefit, a flight benefit, a hotel benefit, a charitable contribution benefit, a return benefit, etc.). The term “complex and dynamically changing goal” is used generally throughout the specification to refer to a goal that requires more than a few financial transactions to achieve and has a cost structure that may change frequently, in, for example, but not limited to, cash basis, rewards exchange basis, etc.

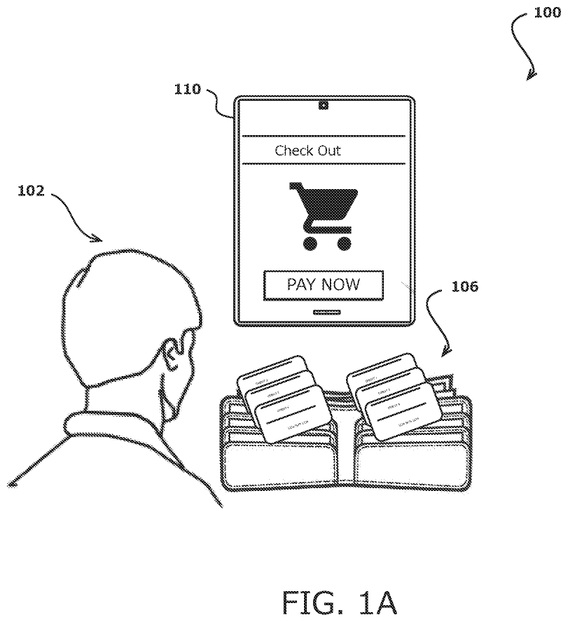

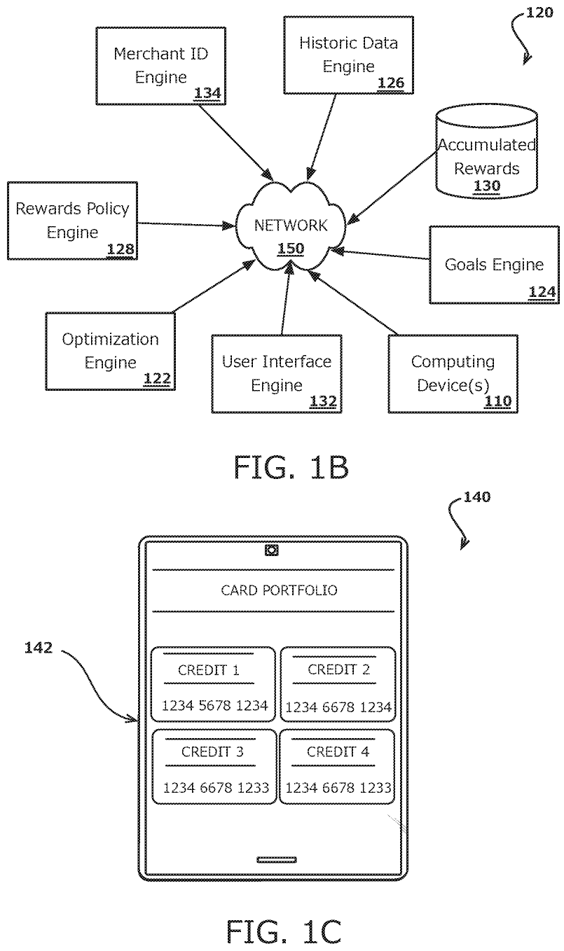

FIG. 1A illustrates example 100 of user 102 attempting to make a purchase with a computing device 110. Although a portable computing device (e.g., a smartphone, an e-book reader, or tablet computer) is shown, it should be understood that various other types of electronic devices having appropriate data processing capabilities that can be used in accordance with various embodiments discussed herein. These devices can include, for example, desktop computers, notebook computers, personal data assistants, cellular phones, video gaming consoles or controllers, smart televisions, wearable computers (e.g., smartwatches or glasses), and portable media players, among others. It should be further noted that although embodiments may be described with respect to online shopping, in which user 102 uses computing device 104 to make a purchase, embodiments herein are applicable to shopping in a physical location. In such embodiments, the computing device 104 may be a point-of-sale terminal and/or the user's computing device 104. As described in more detail below, geo-location data and user input data may be used in certain circumstances to identify the merchant and/or other details about the transaction that the user 102 would like to enter into.

In this example, user 102 is interested making an purchase. In order to make the purchase, the user can use one of a number of payment options, including, for example, credit card and bank cards 106. As described above, although credit and bank cards 106 are illustrated as physical cards in FIG. 1A, the description herein is not limited to such cards and may include, for example, digital accounts that do not provide a physical card. User 102 has opened accounts for credit and bank cards 106 in part because the cards allow for the ability to earn rewards such as airline frequent flyer miles, hotel points, general use points, cash rebates, and other benefits with purchases. User 102, in this example, desires to earn enough rewards to redeem the rewards for a particular goal, e.g., a trip to Paris. However, because credit card and bank cards 106 have different reward structures, where some the cards provide greater rewards for purchases for specific merchant categories, user 102 is not sure which card to use to further their goal. In addition, at least some of the credit and bank cards 106 provide a bonus reward for spending a specified amount within a set period of time, but this information is not readily available and can be frustrating to track for each of the cards. Other factors that may be considered before making a purchase include, for example, the existence of a zero percent interest period for purchases for a particular card, the interest rate for a card for which the consumer may consider carrying a balance, the presence of an annual cap on the points that may be earned for a particular card, impact to credit score, probability of being approved for a particular card, and the like. As such, user 102 may default to a particular card to make the purchase and potentially miss out on maximizing rewards and reward bonuses.

Systems and methods in accordance with various embodiments describe real-time or near real-time systems and methods for maximizing the accumulation, exchange, and/or redemption of credit card rewards for using and/or exchanging the rewards for a specific purpose, such as achieving a complex and dynamically changing goal. FIG. 1B illustrates example system 120 for maximizing the accumulation, exchange, and/or redemption of credit card rewards for using and/or exchanging the rewards for a specific purpose in accordance with various embodiments. The system may include historic data engine 126, accumulated rewards database 130, goals engine 124, computing devices 110, user interface engine 132, optimization engine 122, rewards policy engine 128, and merchant ID engine 134.

Goals engine 124 obtains goal data from a user. The goal data can include, for example, a goal for a travel benefit, a cashback benefit, a flight benefit, a hotel benefit, a charitable contribution benefit, return benefit, investment benefit to an investment account, a digital currency benefit (e.g., a cryptocurrency investment benefit), a gift card benefit, a green benefit (e.g., a combination of investing and charity, including green investing, green charities, carbon credit, etc.), obtaining a low or lowest cost interest rate for transfer balances, and the like. The goals, in certain embodiments, may specify hotel room types, the desired number of hotel rooms, the number of nights for the hotel room; a rental car type, the number of rental cars, the number of days of renting the rental car; any specific brick and mortar store, online shopping store, or company, etc. In certain embodiments, goals from different users may be considered in the recommendation, where the different users may be provided a portfolio of recommended credit card accounts to achieve their specific goals, which may be used to satisfy the combined goals of the group.

Historic data engine 126 obtains financial transaction information associated with a user, where the financial transaction information can include past purchase transaction information from one or more financial accounts (e.g., credit card accounts, checking accounts, savings accounts, etc.) associated with user 102, reward points associated with reward programs associated with user 102, past and/or current account card portfolios, and the like.

Reward policy engine 128 obtains reward program terms for a plurality of reward programs. A variety of different methodologies may be used to retrieve the relevant reward policy data, including but not limited to, data scrapes, API access, etc. The reward programs can be associated with a credit card account, checking account, saving account, etc., and a reward program can specify, for example, a reward program bonus, an amount to spend within a time frame to receive the reward program bonus, the number of miles required to travel to specific locations for various flight statuses, the number of points to stay at a hotel for different number of nights and rooms, the conversion or transfer of reward points from banks or other travel programs such as hotels and other airlines into miles or hotel points, and any other appropriate qualifying information. The rewards policy engine 128 may categorize the various requirements in a database. The credit card accounts, in certain embodiments, can be associated with banking institution policies that specify eligibility requirements for qualifying for a credit card account.

Merchant ID engine 134 can obtain geo-location data and user input data to identify a merchant and/or other details about a transaction that the user 102 would like to enter into.

Optimization engine 122 can generate a recommendation for a portfolio of credit card accounts to achieve specific goals within a period of time given the user's spending habits, the number of credit card accounts desired, etc. Optimization engine 122 may obtain the merchant information from merchant ID engine 134 and may recommend one or more credit card accounts to use for a purchase transaction to achieve a goal that the user would like to accomplish based on data obtained from goals engine 124, historic data engine 126, the reward policy engine 128, accumulated rewards database 130, and merchant data.

User interface engine 132 can illustrate the credit card accounts, timing guidelines and spending guidelines that may be generated by the optimization engine 122 and presented to user 102 via the user device 104.

FIG. 1C illustrates an example 140 of one or more credit card accounts that may be recommended by optimization engine 122 in accordance with various embodiments. The recommended credit card accounts may include new accounts or may be comprised of a combination of new accounts and accounts already associated with user 102. User 102 can apply for credit cards corresponding to the portfolio of credit card accounts, and the credit cards can be used to make purchases. In certain embodiments, an automated card application process applies for each of the cards in the portfolio using user information and in accordance with individual bank requirements. Additionally, or alternatively, the application process can be shared between the user and the system. For example, the system may populate the application forms and the user may submit the forms.

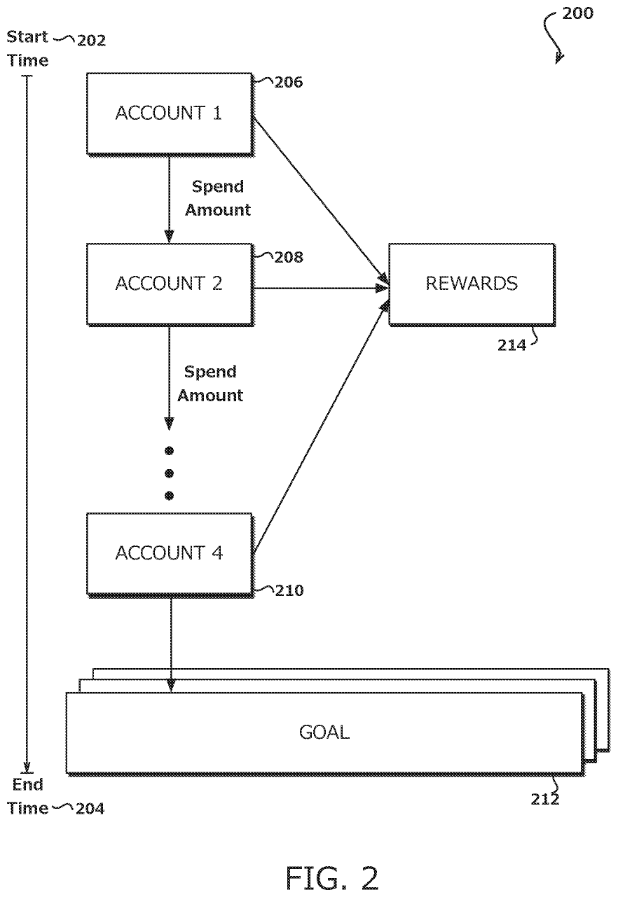

Once the credit card accounts are received, a user can make purchases in accordance with the timing guidelines and spending guidelines. The timing guidelines can describe an order in which to use individual credit cards, credit card upgrade or downgrade options, account cancelation timeline, replacement card recommendations and the time of cancellation and/or upgrade or downgrade, etc. Spending guidelines can correspond to an amount to spend using each of the credit cards, etc. For ease of reference, the timing and spending guidelines are described in more detail in reference to FIG. 2. Thereafter, rewards earned from purchases made using the credit cards in accordance with the timing and spending guidelines can be stored in accumulated rewards database 130 and used to help the user achieve the goals captured by goals engine 124.

In accordance with various embodiments, user device 104 includes, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 110. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application 110 obtains data from the network 110 and displays it to the user within the application 533 interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1B (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1B, but would be readily apparent to a person of ordinary skill in the art. For example, the system may include databases for storing data, and storing features. Other databases and systems may be added or subtracted, as would be readily understood by a person of ordinary skill in the art, without departing from the scope of the invention.

FIG. 2 illustrates an example approach 200 to earning rewards from purchases made in accordance with timing and spending guidelines in accordance with various embodiments. In this example, a user received a portfolio of credit card accounts, timing guidelines, and spending guidelines. As described above, timing guidelines refer to when the user should use a credit card account to execute a purchase transaction. Spending guidelines refer to the amount of money that the user must spend with a credit card account. As described herein, the various timing and spending guidelines can be provided by the optimization engine 122 to help the user achieve his or her goals in an effective and efficient manner. In the exemplary embodiment illustrated in FIG. 2, four credit card accounts, represented by accounts 206, 208, and 210 (as shown) are recommended by the optimization engine 122. The portfolio of credit card accounts (e.g., accounts 206, 208, and 210 (as shown)) can be used to maximize the accumulation, exchange, and/or redemption of rewards 214 for one or more complex and dynamically changing user-selected goals 212 or reward criterion, including, for example, a travel benefit, a cashback benefit, a flight benefit, a hotel benefit, a charitable contribution benefit, a return benefit, investment benefit to an investment account, a green benefit (e.g., a combination of investing and charity, including green investing, green charities, carbon credit, etc.), and the like. In an example, goals might specify a trip to Paris for two, for five days, with business class airplane travel, and five-star accommodation, wherein the entire trip is paid by rewards points. The rewards can include bonus points, airline miles, reward points, hotel points, restaurant points, carbon offsets/credits or a combination thereof.

To help maximize rewards, the timing guidelines define an order in which to use individual credit card accounts, account cancelation timeline, replacement card recommendations and the time of cancellation and/or upgrade or downgrade, etc. Spending guidelines can define an amount to spend using the individual credit card accounts for a user-selected or otherwise determined period of time. For example, FIG. 2 illustrates start time 202 and end time 204, where start time 202 can correspond to the time (e.g., a particular day, day and time, etc.) when the user applies for some combination of the credit card accounts in the portfolio, the time the portfolio was recommended, a user-selected start time, or some other start time. End time 204 can correspond to a user-selected end time, an end time determined by the system, e.g., a time based on the user's spending habits and reward program terms, etc.

The timing and spending guidelines recommend spending a first amount using account 206 within a first period of time, spending a second amount using account 208 within a second period of time, and so on. In an example, historic spending data can be analyzed to determine that a user historically spends $1,000 a month in the summer months, but $2,000 a month in September. To earn the most reward points and bonuses, the timing and spending guidelines may specify to spend $3,000 using account 206 in the first three months to earn a rewards bonus and reward points for the amount spent. The timing and spending guidelines in certain embodiments may recommend opening account 208 account during the second month, and spending $2,000 using account 208 in the next month to earn a rewards bonus associated with account 208 and reward points for the amount spent. In this way, rewards earned from purchases made in accordance with the timing and spending guidelines maximize the rewards earned towards the user's goal for the specified period of time.

In an embodiment, the timing and spending guidelines may be updated to help a user stay on track when earning rewards. In an example, the order in which to use the cards and the amount to spend using each card may be updated based on recent spending data. For example, in the situation it is determined the amount spent on account 206 will not be enough to earn the bonus associated with account 206, then the guidelines can be updated to recommend, for example, using account 208 during the next month, and a new account for the remaining time with an amount to spend. In the situation it is determined the user will satisfy the spending amount associated with account 206, the guidelines can be updated to recommend using account 208 early.

In another example, the order in which to use the cards and the amount to spend using each card may be updated based on a change in the enrollment incentives. For example, in the situation the reward incentive associated with account 206 is changed such that a reward bonus cannot be reached, then the guidelines can be updated to recommend, for example, using account 208 during the next month, and a new account for the remaining time with an amount to spend.

In yet another example, the order in which to use the cards and the amount to spend using each card may be updated based on a change in the costs and exchange values for the reward points. For example, in the situation the reward points associated with account 206 were to be exchanged, and the cost for that exchange causes the reward points earn to fall short of the required number of rewards points, then the guidelines can be updated to recommend, for example, using a new account instead of the current account within a specified period of time for a specified amount to help the user stay on track.

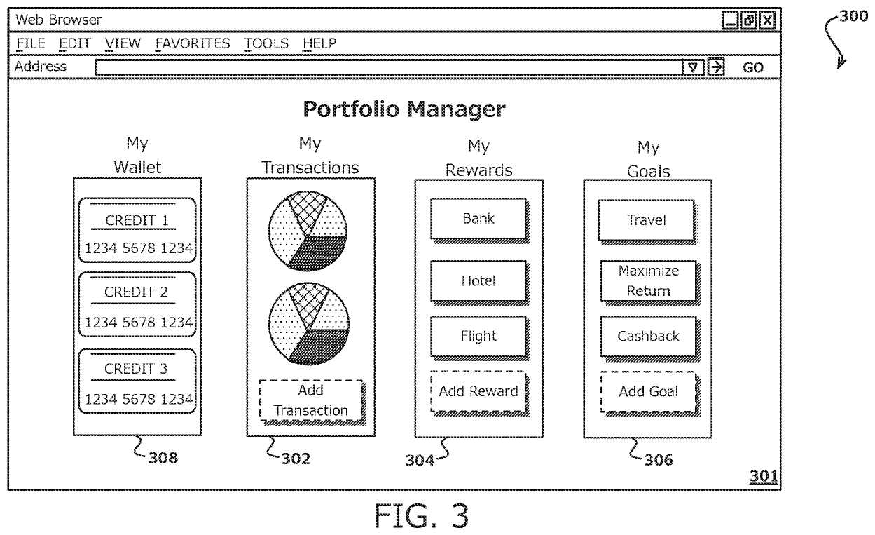

FIG. 3 illustrates an example interface 300 that can be utilized in accordance with various embodiments. In this example, a user can utilize portfolio manager 301 to provide information that can be used to determine a portfolio of credit card accounts. For example, a user can use my transactions pane 302 to provide financial transaction information associated with the user. The financial transaction information can include, for example, past purchase transaction information from one or more financial accounts associated with the user such as, for example, information relating to the consumer bank accounts, investment accounts, loan accounts, credit card accounts, and any other accounts that may be affected by transactions entered into by the user, past and/or current account card portfolios, and the like. In an embodiment, the information may be obtained from appropriate financial or other servers managing user financial and other relevant information periodically or manually uploaded by the user. In other instances, the transaction information may be obtained via banking credential access that may be provided by the user, API access associated with financial transaction that may be tracked by a financial institution, data tracked or collected credit card accounts provider, credit reports, and other data stores that contain financial and transaction information associated with the user. My transaction pane 302 can provide continual access to a current view of all financial information.

My rewards pane 304 can be used to provide rewards that a user may have accumulated. The reward information can include, for example, reward account balances for various reward accounts that may or may not be associated with a credit card account, for example. The reward accounts can be comprised of, for example, frequent flyer miles, hotel points, general use points, cash rebates, and other rewards. The reward accounts can also include information relating to details of the reward programs, reward point totals, redemption requirements for each reward account, reward bonus information, and any other appropriate reward program terms. In various embodiments, reward accounts may be connected with a credit card account; however, it should be noted that in certain embodiments, a reward account may be a stand-alone account, and thus, not connected to a credit card account.

My goals pane 306 can be used to select one or more goals desired by the user, such as a target for cash redemption, maximizing cashback, a gift card, an air ticket, a hotel stay, a vacation package, a charitable contribution benefit, return benefit, investment benefit to an investment account, a digital currency benefit (e.g., a cryptocurrency investment benefit), a gift card benefit, a green benefit (e.g., a combination of investing and charity, including green investing, green charities, carbon credit, etc.), and others described herein.

The goals can be prioritized in order of importance or priority. For example, the goals can be arranged in order of importance, assigned a hierarchy of importance (e.g., first level, second level, etc.), assigned a value of importance (e.g., percentage value or numerical value), or otherwise indicate a level of importance.

The goals can be a combination of goals that may change or be updating, such as, for example, a trip to Paris for two, for five days, with business class airplane travel, and five-star accommodation, wherein the entire trip is paid by rewards points.

The user can indicate a date for when the user desires to satisfy the goal. For example, the user may set a time occurring in six months for completing the points requirement for a flight and hotel in a favorite destination. In one instance, my goals pane 306 may display fulfillment or progress percentage, which indicates total reward points accumulated for the entire goal or segments of the goal, reward points remaining for the entire goal or segments of the goal, time until completion of the entire goal or segments of the goal, etc.

My wallet pane 308 is operable to show stored or connected credit card account or other card account details. In an embodiment, my wallet pane 308 stores information for each of the consumer's accounts sufficient to provide the information required for a transaction using a credit card or other card. Additionally, my wallet pane 308 can show any banking institution policies associated with the accounts. For example, for a credit card account, the banking institution policies for that account may specify eligibility requirements for qualifying for the corresponding credit card account. My wallet pane 308 also provides the optimal wallet to achieve a specific goal. This can include, for example, presenting the credit cards needed and the sequencing of those cards to achieve goal. Additionally, or alternatively, my wallet pane 308 can display the credit cards that the user has already signed up for, and can also display cards that the user can sign up for in the future to achieve his or her goal.

In various embodiments, a dashboard may be provided to provide a view of the overall progress in achieving any provided goals. Additional information can be presented, including, for example, a comparison of the price in points and miles to the dollar cost of flights and hotels, an activity log, upcoming annual fees, impact to credit score, credit card recommendations, credit card upgrade or downgrade options, an estimated time for reaching the goal(s), the number of reward points needed to reach the goal(s), upcoming bonuses points, fulfillment or progress percentage, which can indicate the total reward points accumulated for the entire goal or segments of the goal, reward points remaining for the entire goal or segments of the goal, time until completion of the entire goal or segments of the goal, and other such notifications and/or alerts.

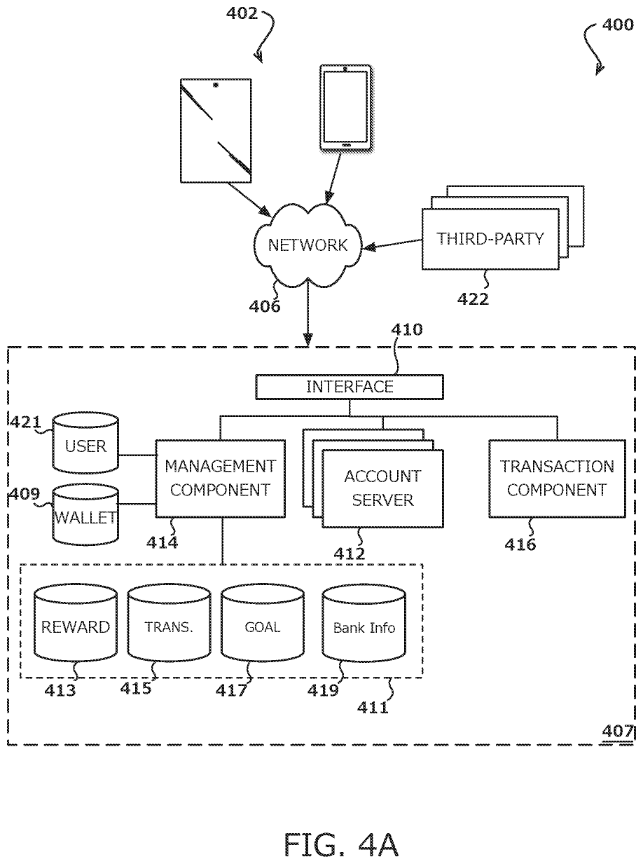

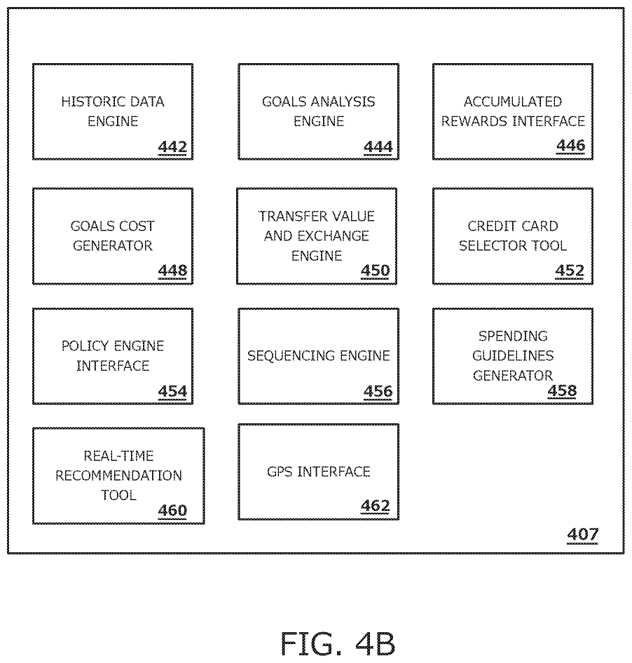

FIG. 4A illustrates an example environment 400 in which aspects of the various embodiments can be implemented. More specifically, the exemplary environment 400 may be comprised of user devices 402, third parties 422, optimization engine 407, and a network 406. In this example, a financial account management system includes account server 412, management component 414, and transaction component 416. The financial account management system may also include one or more data stores 409, including, for example, rewards data store 413, transaction data store 415, goals data store 417, and banking policies data store 419. It should be noted that although the data stores are shown as separate data stores, data from the data stores can be maintained across fewer or additional data stores. The data stores can be accessed by at least management component 414 in order to perform the functionality of the corresponding component; other components, systems, services, etc. may access the data stores. Although the financial account management system is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein. For example, the components may perform the functionality of, or communicate with historic data engine 442, goals analysis engine 444, accumulated rewards interface 446, goals cost generator 448, transfer value and exchange engine 450, credit card selector tool 452, policy engine interface 454, sequencing engine 456, spending guidelines generator 458, real-time recommendation tool 460, GPS interface 462 of FIG. 4B.

The financial account management system can maintain rewards data store 413, goals data store 417, and banking policies data store 419. As described, although the data stores are shown as separate data stores, data from the data stores can be maintained across fewer or additional data stores. As further described herein, the data stores can be maintained locally or remote the components described herein. For example, a third-party can maintain some of the data stores or all of the data stores, among other such options. Rewards data store 413 may include information specifying reward program terms for a plurality of reward programs. A reward program in various embodiments can be associated with a credit card account, one or more hotels, one or more airlines, merchants, or a combination thereof. The reward program can specify, for example, a reward program bonus, an amount to spend within a time period to receive the reward program bonus, reward point availability, nature of reward points earned, earning rate of reward points, enhanced point-earning based on nature of merchant, bonus period, special promotions, and similar data and any other appropriate qualifying information. Also stored is information relating to expiration conditions and dates for points in various programs and earning caps for points from multiple cards and in various programs. In addition, data is stored relating to the availability of points from other sources, such as earning airline miles by flying on the sponsoring airline, and the anticipated earning rate of points from such sources. Policy engine interface 454 may be utilized to obtain the data for rewards data store 413.

Goals data store 417 may include information for a user-defined goal or reward criterion, such as a travel benefit, a cashback benefit, a flight benefit, a hotel benefit, a charitable contribution benefit, return benefit, investment benefit to an investment account, a digital currency benefit (e.g., a cryptocurrency investment benefit), a gift card benefit, a green benefit (e.g., a combination of investing and charity, including green investing, green charities, carbon credit, etc.), and the like. The goals may in certain embodiments may specify hotel room types, the desired number of hotel rooms, the number of nights for the hotel room; a rental car type, the number of rental cars, the number of days of renting the rental car; any specific brick and mortar store, online shopping store, or company, etc. In certain embodiments, goals from different users may be considered in the recommendation, where the different users may be provided a portfolio of recommended credit card accounts to achieve their specific goals, which may be used to satisfy the combined goals of the group, etc. Goals analysis engine in certain embodiments can obtain the goal data for goals data store 417.

Banking policies data store 419 may specify eligibility requirements for qualifying for a corresponding credit card account. The eligibility requirements can include, for example, a limit on a number of new credit card accounts for a period of time, an income minimum for the respective credit card accounts, a minimum credit score for the respective credit card accounts, a welcome bonus eligibility, credit limits, required minimum payments, as well as any other information relevant to a credit card account. Policy engine interface 454 may obtain the data for banking policies data store 419.

Transaction component 416 is operable to obtain financial transaction information associated with a plurality of users and maintain that data in transaction data store 415. The financial transaction information can include, for example, past purchase transaction information from one or more financial accounts associated with the user such as, for example, information relating to the consumer bank accounts, investment accounts, loan accounts, credit card accounts, and any other accounts that may be affected by transactions entered into by the user. Such additional information may include information relating to the value of the ability to extend a payment period. The past purchase transaction information can be classified by major spending categories and may be used to determine the optimal credit cards for maximizing a user's return on purchases. Additional information may also include the interest rate and terms associated with each card. Transaction component 416 with historic data engine 442 may operate together or individual to obtain the data for data store 415.

Client device(s) 402 can submit requests across at least one network 406 to be received by provider environment 407 maintained by a provider of the financial management system. As mentioned, in at least some embodiments, the request can be to for a recommendation on credit card or other payment accounts that maximize rewards associated with the payment accounts for at least one user-defined goal or reward criterion (e.g., a travel benefit, a cashback benefit, a flight benefit, a hotel benefit, a charitable contribution benefit, a return benefit, etc.)

The provider environment can include any appropriate resources for providing recommendations and other content, as may include various servers, datastores, and other such components known or used for providing content from across a network (or from the “cloud”).

Client device(s) 402 can be any appropriate computing device having appropriate data processing capabilities that can be used in accordance with various embodiments discussed herein, such as may include a desktop computer, a thin client device or “dummy terminal,” a smartphone, an e-book reader, a tablet computer, a notebook computer, a personal data assistant, a video gaming console or controller, a smart television, a wearable computer (e.g., a smartwatch or glasses), or a portable media player, among others. The client device(s) 402 may have varied local computing resources, such as may include central processing units and architectures, memory, mass storage, graphics processing units, communication network availability and bandwidth, etc.

The at least one network can include a wired and/or wireless network, as may include the Internet, a cellular network, a local area network (LAN), an Ethernet, an Intranet, and the like.

In this example, a request received to provider environment 407 can be received by an interface layer 410 of the environment. Interface 410 may include any software and/or hardware components configured to send and receive communications and/or other information between client device(s) 402 and third-parties 422. Third parties can include, for example, various financial and other information management servers. In various embodiments, interface 410 may include a data interface and service interface may be configured to periodically receive data sets, requests, and/or any other relevant information to facilitate financial management and display of such information. Interface 410 can include any appropriate components known or used to receive requests or other data from across a network, such as may include one or more application programming interfaces (APIs) or other such interfaces for receiving such requests and/or data. Interface 410 might be owned and operated by a provider, or leveraged by a provider as part of a shared resource or “cloud” offering.

If the request is a request for a set of credit card accounts, payments accounts, reward accounts, or a combination thereof, information for the request (e.g., user goals or reward criterion, a number of requested accounts, timeline or end time, etc.) can be directed to management component 414, which can obtain information from one or more appropriate data stores or another such repository to be sent back across the network(s) to the requesting client device. For example, management component 414 can analyze the request and information in data stores 411 to determine a portfolio of credit card accounts to maximize the rewards earned towards the user's goal for the specified time. The information in data stores 411 can include, for example, financial transaction information, reward program terms for the plurality of reward programs, user-defined goals, banking institution policies for the potential credit card and other accounts, a user's current available cards, existing reward program points, a user's preferences, such as the maximum number of cards an individual prefers, etc.

In an example, when determining the portfolio of credit cards for a travel goal, the management component 414 analyzes the combination of any signup bonuses, cashback, and other benefits of all available credit cards as well as the ease and conversion ratio of the reward points to maximize a return on a user's spending and help a user reach travel goals even faster for example than merely optimizing for spending category returns on everyday spending. In various embodiments, management component 414 with goals analysis engine 444, accumulated rewards interface 446, goals cost generator 448, transfer value and exchange engine 450, credit card selector tool 452, policy engine interface 454, sequencing engine 456, merchant ID engine 134, and spending guidelines generator 458 generate the portfolio of credit cards.

In another example, when determining the portfolio of cards for maximizing cashback, a user can decide how many cards they want in their optimal wallet, and they can decide whether they want the wallet to be static (not change), or dynamic (e.g., automatically adds new card and remove old cards). This may also apply to both charitable donations and maximizing overall return goals.

In yet another example, when determining the portfolio of cards for flight, hotel, and travel goals, management component analyses a user's preferences for a given airline, hotel, or combinations thereof, as well as their preferences for airline travel class, and tier of hotel. Based on a user's desired destination, duration, the number of travelers, and other preferences, management component 414 can recommend a portfolio of credit card accounts and an order in which to apply for the cards. Management component 414 also factors in a user's existing points and mileage balance with the award programs they participate in into the recommended portfolio of accounts. In the situation if a user has enough points for their desired trip, management component 414 recommends which program to transfer points to if necessary.

In any situation, once management component 414 processes the appropriate information for one or more goals, for a determined end goal time, management component can generate and assign a score such as a selection score to individual potential credit card accounts. A selection score, in an embodiment, can quantify a degree to which rewards earned through the use of a corresponding credit card account maximizes the user goal. In certain embodiments, a score is assigned to each card for purchases in each category. Some cards have only one purchase category because all purchases made with the card earn the same rewards. Still, some cards have multiple purchase categories, so that the use of a card for a purchase in a general category may have a low score, and the use of the card for a purchase in a particular category may have a higher score. In addition, particular card issuers may operate promotions for specific merchants or categories of merchants or may have ongoing relationships with specific merchants, so that the use of a particular card for a merchant associated with a promotion or a special relationship may earn points at a higher rate.

It should be noted that any number of scoring mechanisms may be implemented, such as a scoring mechanism maximizing rewards earned for one or more goals, a scoring mechanism assigning an actual cash value to such factors as interest costs and cashback rewards, and a cash equivalent value to reward points, with the cash value assigned to reward points being higher when the point total is near a level required to achieve the desired reward. The valuation assigned to reward points from different programs may vary. For example, reward points associated with a program regularly used by the consumer may be given a higher value.

The selection scores (e.g., a vector of scores) can be used to determine a portfolio of credit card accounts. In an embodiment, the credit card accounts can be new accounts or a combination of new and current credit card accounts. The portfolio of credit card accounts can be maintained in data store 409 or another appropriate data store such as user data store 421.

Once the portfolio of credit card accounts is determined, timing guidelines corresponding to an order in which to apply or use individual credit card accounts in the portfolio can be determined. For example, financial institutions that issue credit card accounts may prevent users from being approved for individual cards if they do not meet specific criteria. As an example, a specific criterion may state that an individual will not be approved for a new credit card if they have opened more than, e.g., five credit cards across all banks in 24 months. In another example, the timing guidelines can specify when a user is able to apply for a new card given the time nature of the banking rules. For instance, with most credit cards, there is a necessary time period one must wait before one can apply for the same card again, be approved, and receive the signup bonus again. The guidelines can recommend downgrading or canceling a card when an annual fee is coming due. This can be based on, for example, the positive return generated from a particular credit card from spending data against the cost of the annual fee. In the situation the return satisfies a threshold, e.g., the annual fee, the guidelines may recommend downgrading the card.

In an embodiment, spending guidelines may be provided with the portfolio. Spending guidelines can correspond to an amount to spend using the individual credit card accounts to maximize the number of bonus points that can be earned based on the banking institution policies and reward program terms associated with the credit cards.

Account server 412 can provide the portfolio of credit card accounts, the timing guidelines, and the spending guidelines to the appropriate client device. For example, account server 412 can maintain a portal or other such website that a user can access the accounts, timing, and spending guidelines. A user can apply for credit cards corresponding to the portfolio of credit card accounts, and the credit cards can be used to make purchases. In certain embodiments, an automated card application process applies for each of the cards in the portfolio using user information and in accordance with individual bank requirements. Additionally, or alternatively, the application process can be shared between the user and the system. For example, the system may populate the application forms and the user may submit the forms. Thereafter, rewards earned from purchases of goods and/or services made in accordance with the timing and spending guidelines maximize the rewards earned towards the user's goal for the specified period of time.

In various embodiments embodiment, when a purchase is contemplated, if details of the purchase are provided to management component 414, management component 414 may score each card with respect to the purchase and either recommend the highest scoring card or simply select the highest scoring card for the purchase, depending on consumer preferences. In certain embodiments, details of a user's location (e.g., geographic location or GPS location) can be used to identify nearby stores, which can be used to supplement details of a current purchase and/or otherwise be used to select a credit card for a purchase. In the situation a card not included in the portfolio would be useful to maximize rewards for at least one goal or reward criterion, a notification or other information can be provided to the user, where the information can include details about the card, rewards missed for not using the card, updated timing and spending information should the card be added to the portfolio, and the like.

FIG. 4B illustrates additional components that may be utilized in environment 400 for generating a portfolio of credit card accounts in accordance with various embodiments. The components can include historic data engine 442, goals analysis engine 444, accumulated rewards interface 446, goals cost generator 448, transfer value and exchange engine 450, credit card selector tool 452, policy engine interface 454, sequencing engine 456, spending guidelines generator 458, real-time recommendation tool 460, GPS interface 462.

Historic data engine 442 obtains historical spending data associated with a user. The historical spending data may be comprised of financial transaction information associated with a user, where the financial transaction information can include past purchase transaction information from one or more financial accounts (e.g., credit card accounts, checking accounts, savings accounts, etc.) associated with the user, reward points associated with reward programs associated with the user, past and/or current account card portfolios, and the like.

The historic data engine 442 may also compute future spending trends based on historic data. In one embodiment, the historic data engine 442 may identify trends and anomalies in the user's historic spending data. For example, if a user had unusually large one time purchases (associated with a life event such a relocation move), the historic data engine 442 may remove those spending data points before computing a future expected spending trends. Moreover, the historic data engine 442 may compute patterns in spending based on historic data. For example, if a user tends to spend more money in September, then the data may be used to make spending, timing, and credit card account recommendations for maximizing rewards in accordance with the description herein.

Goals analysis engine 444 obtains user defined goals that may be input by a user, and analyzes the user defined goals to identify goal components, wherein each goal component may be categorized in a component category. A user defined goal may can include, for example, a first-class round trip flight to Paris and a five-night stay in Paris at a five-star hotel In this scenario, the goals analysis engine 444 may identify a round trip flight to Paris as a first component, and a five-night stay at a five-star hotel as a second component of the user defined goal. The goals analysis engine 444 may further identify component category that is associated with each one or more components that are identified. In the above referenced example, the flight component may be categorized as a travel component category, and the hotel stay component may be categorized as an accommodation category. In one embodiment, each component category may be associated with a reward offering that may be used to redeem against the category. For example, reward miles may be used to redeem components associated with the travel component category. Similarly, reward points may be used to redeem components associated with the accommodation category. Other user defined goals and/or goal components and/or component category may include a travel benefit, a cashback benefit, a flight benefit, a hotel benefit, a charitable contribution benefit, return benefit, investment benefit to an investment account, a digital currency benefit (e.g., a cryptocurrency investment benefit), a gift card benefit, a green benefit (e.g., a combination of investing and charity, including green investing, green charities, carbon credit, etc.), and the like.

Other user defined goals that the goals analysis engine 444 may analyze may include preferences or requirements regarding hotel room types, the desired number of hotel rooms, the number of nights for the hotel room; a rental car type, the number of rental cars, the number of days of renting the rental car; any specific brick and mortar store, online shopping store, or company, etc. The user defined goals can be complex and dynamically changing, such as a trip to Paris for two, for five days, with business class airplane travel, and five-star accommodation, wherein the entire trip is paid by rewards points. In certain embodiments, goals from different users may be considered in the recommendation, where the different users may be provided a portfolio of recommended credit card accounts to achieve their specific goals, which may e used to satisfy the combined goals of the group.

In one embodiment, the goals analysis engine 444 may identify one or more providers that may fulfill one or more components of the user defined goal. For example, if a user defined goal is comprised of a flight to Paris, then the goals analysis engine 444 may identify all the airline or flight providers that may offer air travel services from the user's preferred starting airport to the appropriate destination airport in or around Paris. Similarly, the goals analysis engine 444 may identify five-star hotel in and around the Paris area if the user defined goal is comprised of five-star accommodation in Paris. [I am not sure but you could go down the path of pointing out if the user does not have a preference of airline or hotel—we compute the cheapest ones. Alternatively—where user has a preference—the goals engine is based on preferred airline and hotel].

Accumulated rewards interface 446 interfaces with credit card account and/or rewards accounts to obtain rewards that a user may have accumulated. For example, accumulated rewards interface 446 can include an existing rewards balance with one or more reward programs, including, for examples, rewards from credit cards, airlines, hotels, merchants, and the like. In certain embodiments, as rewards are accumulated, for example, through use of credit cards associated with these rewards, hotel and/or airline miles earned, etc., accumulated rewards interface 446 can be updated to reflect the change in rewards.

Goals cost generator 448 computes cost associated with fulfilling one or more components of the user defined goal. In one embodiment, the goals cost generator 448 computes costs associated with the components in the user defined goal in units of reward offerings associated with one or more providers. Units of reward offering generally refers to various units of rewards that may be offered by a rewards provider, such as, but not limited to, reward miles, reward points, reward rebates, etc. For example, if a user defined goal is comprised of a travel component and a hotel stay component, the goals cost generator 448 may identify the number of reward miles that may be necessary to complete the airline travel, and the number of reward points that may be necessary to redeem towards the hotel stay.

In one embodiment, goals cost generator 448 computes costs for each vendor that provides an offering capable of fulfilling a component of the user defined goal. For example, if air travel is a component of a user defined goal, then the goal costs generator may identify every vendor or carrier that may offer flight services from a user's preferred airport to airports in or around a goal destination. Once the appropriate vendors or carriers are identified, the goals cost generator 448 computes a cost associated with vendor or carrier in units of reward offerings associated with one or more reward providers.

In one embodiment, the goals cost generator 448 applies the accumulated reward points to relevant component costs to obtain remaining costs associated with the one or more components in the user defined goal. More specifically, in accordance with an embodiment of the invention, the goals cost generator 448 interfaces with the accumulated rewards interface 446 to obtain the rewards accumulated by the user and applies those rewards to each relevant component of the user defined goal to obtain remaining costs. For example, if a user defined goal is comprised of airline travel, and the user has accumulated some miles that may be applied towards airline travel, then the goals cost generator 448 reduces the cost of airline travel cost based on applicability rules. For example, if a user defined goal is comprised of airline travel, and the user has accumulated 10,000 Delta® travel rewards miles, then the goals cost generator 448 may reduce the costs associated with the travelling on a Delta® carrier. However, in one instance, if the Delta® travel rewards are not redeemable towards an American Airlines® flight, then the goals cost generator 448 may not reduce the costs associated with the American Airlines® flight.

In one embodiment, once the costs associated with each vendor or carrier are computed, the goals cost generator 448 applies the accumulated rewards to each relevant and applicable computed costs and appropriately reduces the costs associated with each vendor. In one embodiment, the goals cost generator 448 reduces costs by applying the accumulated rewards points to the overall costs. In other embodiments, the goals cost generator 448 may identifying an exchange pathway for converting the accumulated rewards so that the accumulated rewards can be applied to the identified costs associated with each carrier or vender. Thereafter, the goals cost generator 448 may identify the lowest cost carrier—based on the user's accumulated rewards—to fulfill a component of the user generated goal.

Transfer value and exchange engine 450 applies value determination analysis to identify a value score associated with the one or more remaining costs associated with the one or more components. In other words, the transfer value and exchange engine 450 computes a value associated with each cost computed by the goal cost generator 448. For example, if the goal cost generator 448 identifies Delta®, Frontier®, and American Airlines® as vendors that are capable of fulfilling a component of a user defined goal, and computes the remaining cost associated with each vendor offering, then the transfer value and exchange engine 450 computes a value associated with each cost computation associated with each carrier/vendor. In other words, certain rewards offerings or units may be more valuable than others—the transfer value and exchange engine 450 accounts for that. For example, a Delta® rewards mile may be worth two Frontier® reward mile. A variety of different methodologies may be used to compute value, including, but not limited to, referencing an empirical database that may assign a value to a unit of rewards offering based on a currency (such as the US dollar). In other embodiments, an exchange database may be consulted to determine identify the relative value of a unit of reward offering relative to other units of reward offerings.

The transfer value and exchange engine 450 may also identify reward offerings in two or more component categories that are in a same transfer family and identify those transfer families. 0-

Credit card selector tool 452 identifies credit card accounts that issue rewards in the same transfer family as the ones identified by the transfer value and exchange engine 450. In one embodiment, in accordance with this disclosure, the rewards optimization system may prioritize credit card accounts that issue rewards in the same transfer family. In other embodiments, credit card accounts that issue rewards in different transfer families may be considered if the value of the rewards that can be obtained from those rewards is greater than the value of rewards that can be obtained from offerings in the same transfer family.

In one embodiment, the credit card selector tool can obtain merchant information from GPS interface 462 or other appropriate component/engine and categorize the merchant associated with a potential transaction and suggest a credit card, from the cards in the consumer's wallet, to achieve a goal that the user would like to accomplish based on data obtained from goals engine 444, historic data engine 442, policy engine interface 454, and accumulated rewards interface 446. In various embodiments, credit card selector tool 452 with management component 414 processes the appropriate information for one or more goals, for a determined end goal time, and generates a score such as a selection score for individual potential credit card accounts.

Policy engine interface 454 obtains policy data associated with one or more credit card accounts that are in the identified transfer families. The policy data is comprised of rules regarding the number and type of credit card accounts from one or more providers that a user may be permitted to enroll in. A variety of different methodologies may be used to retrieve the relevant reward policy data, including but not limited to, data scrapes, API access, etc. The term credit card account is used generally herein and may refer to with a credit card account, checking account, saving account, etc.,

In one embodiment the policy engine interface 454 may also obtain reward offers from the identified new credit card accounts and the credit card account data associated with the user. The reward offers may comprise of reward bonuses that may be earned by, for example, enrolling with a credit card account, remaining enrolled with a credit card account for a period of time, spending a predetermined amount of money with a newly enrolled credit card account, and spending a predetermined amount of money in a predetermined amount of time with a newly enrolled credit card account, accruing a number of miles required to travel to specific locations for various flight statuses, accruing a number of points to stay at a hotel for different number of nights and rooms, the conversion or transfer of reward points from banks or other travel programs such as hotels and other airlines into miles or hotel points, and any other appropriate qualifying information. The policy engine interface 454 may categorize the various requirements in a database. The credit card accounts, in certain embodiments, can be associated with banking institution policies that specify eligibility requirements for qualifying for a credit card account.

Sequencing engine 456 generates an optimal wallet of credit card account that may be used by a user to earn sufficient rewards that may be redeemed to purchase the user defined goal. The optimal wallet may be comprised on new credit card account that are not associated with the user as well as credit card accounts that are associated with the user. In one embodiment, the sequencing engine 456 generates an optimal wallet based on the number of credit card accounts desired, banking institution policies (which, as described above, may restrict the number of credit cards that a user may be enrolled in from a given provider at any given time), reward program terms associated with the credit cards, historic spending data, and the credit card accounts that are currently associated with the user.

In one embodiment, the sequencing engine 456 generates an order in which to apply or use individual credit card accounts within the optimal wallet to earn specific rewards within a period of time given the user's spending habits, and/or other factors. For example, financial institutions that issue credit card accounts may prevent users from being approved for individual cards if they do not meet specific criteria. As an example, a specific criterion may state that an individual will not be approved for a new credit card if they have opened more than, e.g., five credit cards across all banks in 24 months. In another example, the timing guidelines can specify when a user is able to apply for a new card given the time nature of the banking rules. For instance, with most credit cards, there is a necessary time period one must wait before one can apply for the same card again, be approved, and receive the signup bonus again. The guidelines can recommend downgrading or canceling a card when an annual fee is coming due. This can be based on, for example, the positive return generated from a particular credit card from spending data against the cost of the annual fee. In the situation the return satisfies a threshold, e.g., the annual fee, the guidelines may recommend downgrading the card.

Spending guidelines generator 458 generates an amount to spend using the individual credit card accounts to maximize rewards accumulation for redemption towards a user specified goal. In one embodiment, the timing and spending recommendations comprise of a recommendation to enroll for a credit card account at a particular time and/or spending a particular amount of money with a credit card account within a period of time to obtain relevant rewards including bonus rewards.

Merchant ID engine 134 obtains merchant information associated with a purchase transaction that the user desires to transact with. In an instance of online transaction, a user may navigate to a merchant site and initiate a transaction flow to purchase one or more items or services. At the point of purchase, the merchant ID may be obtained by the merchant ID engine 134, which can further categorize the merchant and the merchant information may be used to identify credit card accounts within the optimal wallet that may enable the user to earn maximum rewards associated with the purchase transaction. In one embodiment, the recommendation may be made in real-time via, for example, a browser plugin, and the merchant information may be obtained in real-time via a plugin or the like.

GPS Interface 462 can obtain geo-location data and user input data to identify a merchant and/or other details about a transaction that a user would like to enter into.

Real-time recommendation tool 460 can provide a recommendation on which account to use for a particular purchase and recommended updates for timing and spending guidelines to help a user stay on track when earning rewards.

In accordance with various embodiments, additional or alternative components and elements can be used in such a system in accordance with the various embodiments. Accordingly, it should be noted that additional services, providers, and/or components can be included in such a system, and although some of the services, providers, components, etc., are illustrated as being separate entities and/or components, the illustrated arrangement is provided as an example arrangement and other arrangements as known to one skilled in the art are contemplated by the embodiments described herein. In accordance with various embodiments, the various components described herein may be performed by any number of server computing devices, desktop computing devices, mainframe computers, and the like. Individual devices may implement one of the components of the system. In some embodiments, the system can include several devices physically or logically grouped to implement one of the modules or components of the system. For example, the system can include various modules and components combined on a single device, multiple instances of a single module or component, etc. In one specific, non-limiting embodiment, management component 414 can execute on one device, and transaction component 416 can execute on another device. In another embodiment, the components and/or systems can execute on the same device or other combination of devices.

In some embodiments, the features and services provided by the system may be implemented as web services consumable via a communication network. In further embodiments, the system is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

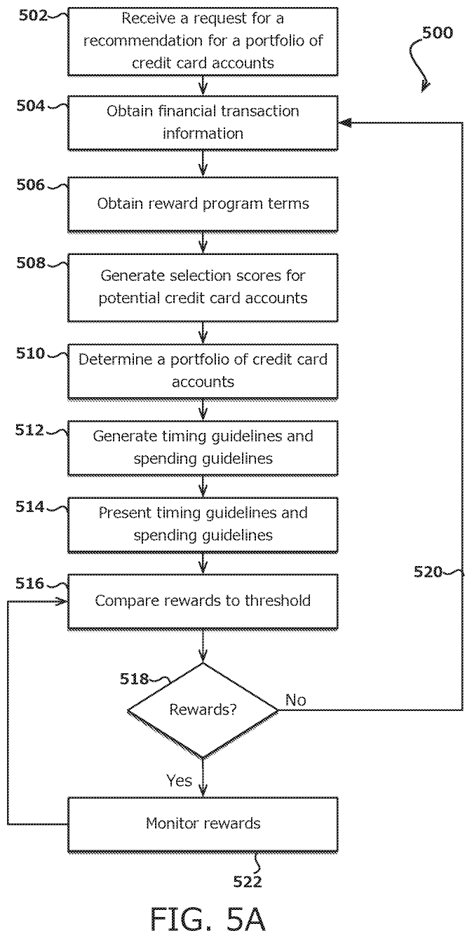

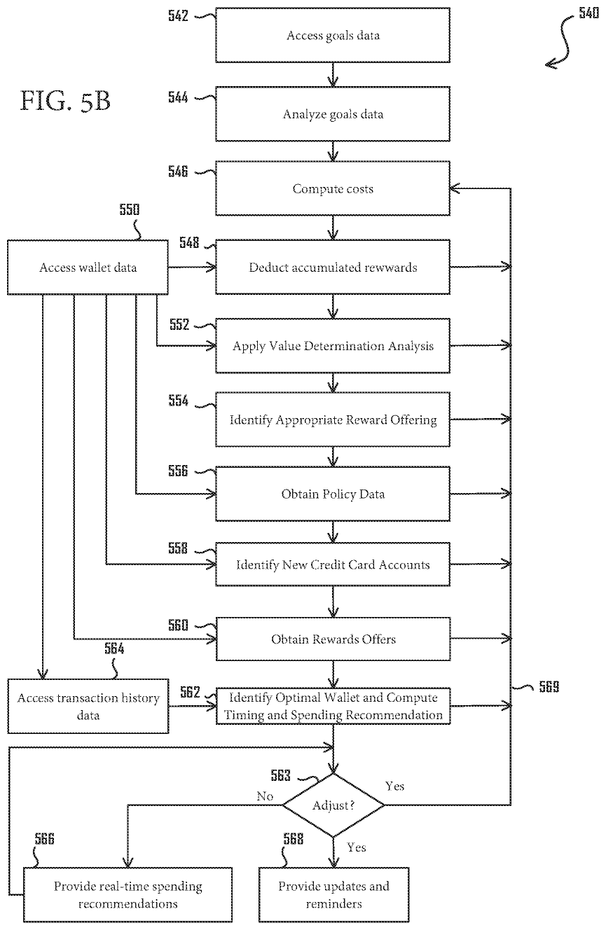

FIG. 5A illustrates an example process 500 for generating a portfolio of credit card accounts in accordance with various embodiments. It should be understood that there can be additional, fewer, or alternative steps performed in similar or alternative orders, or in parallel, within the scope of the various embodiments unless otherwise stated. In this example, a request for a recommendation for a portfolio of credit card accounts can be received 502. The request may be associated with additional information such as a complex and dynamically changing goal, a time frame within which the user would like to accomplish the goal(s), the number of new credit card accounts the user wishes to sign-up for, etc. Financial transaction information associated with the user can be obtained 504, where the financial transaction information can include past purchase transaction information from one or more financial accounts associated with the user, reward points associated with reward programs related to the user, and the like. Reward program terms for a plurality of reward programs can be obtained 506. In various embodiments, the reward programs can be associated with a credit card account, and a reward program can specify, for example, a reward program bonus, an amount to spend within a time frame to receive the reward program bonus, and any other appropriate qualifying information. The credit card accounts, in certain embodiments, can be associated with banking institution policies that specify eligibility requirements for qualifying for a corresponding credit card account. The financial transaction information, the reward program terms for the plurality of reward programs, and banking institution policies for corresponding credit card accounts can be analyzed to generate 508 selection scores (e.g., a vector of scores) for potential credit card accounts. A selection score, in an embodiment, quantifies a degree to which rewards earned through the use of a corresponding credit card account maximizes the user goal. The selection scores can be used to determine 510 a portfolio of credit card accounts. In an embodiment, the credit card accounts can be new accounts or a combination of new and current credit card accounts. Once the portfolio of credit card accounts is determined, timing guidelines and spending guidelines can be generated 512. The timing guidelines correspond to an order in which to use individual credit card accounts in the portfolio of credit card accounts. The spending guidelines correspond to an amount to spend using the individual credit card accounts to maximize the number of bonus points that can be earned based on the banking institution policies and reward program terms associated with the credit cards. The portfolio of credit card accounts, the timing guidelines, or the spending guidelines can be presented 514 to the user. Thereafter, rewards earned from purchases made in accordance with the timing and spending guidelines maximize the rewards earned towards the user's goal for the specified period of time. The rewards earned can be compared 516 to a threshold at particular intervals of time to determine 518 whether the rewards earned satisfy the threshold. In the situation the rewards earned do not satisfy the threshold, and thus the user may be behind schedule to earn enough rewards for any goals, a notification or other alert can be generated and provided to the user identifying the delay. Additionally, or alternatively, the process can iterate 520 to identify credit cards that may help the user reach any specified goals within the time period. In the situation new cards are identified, and the user accepts, updated spending and timing guidelines may be presented to the user. In the situation the user the rewards earned satisfy the threshold, the rewards earned can be continuously monitored 522 or monitored per an interval, and compared 516 to the threshold until the goal(s) are met or another stopping condition is satisfied.

FIG. 5B illustrates an example process 540 for providing real-time spending recommendations in accordance with various embodiments. In this example, goals data is accessed 542. The goal data may be comprised of a user defined goal that may be complex and dynamically changing, such as a trip to Paris for two, for five days, with business class airplane travel, and five-star accommodation, wherein the entire trip is paid by rewards. In one embodiment, the user defined goal can be broken down into two or more components (such as a airline travel and hotel stay in the above reference example), and the component itself may be categorized in one or more component categories (such as “travel” in relation to airline travel, and “accommodation” in relation to hotel stay). A user defined goal may be comprised of a variety of components, including, but not limited to redemption for air travel, redemption for car rental, redemption for shopping at a particular business or merchant, redemption for cashback, redemption for earning cryptocurrency, redemption for investments, redemption for gifts or gift cards, redemption for charitable contributions, redemption for green spending (e.g., a combination of investing and charity, including green investing, green charities, carbon credit, etc.), a combination thereof, etc. The variety of components may be categorized in a variety of component categories, including, but not limited to travel category, accommodation category, cashback category, charitable contribution category, return category, investment category, digital currency category, etc. Roughly, each component category may be associated with a reward offering that may be used to redeem against the category. For example, reward miles may be used to redeem components associated with the travel component category. Similarly, reward points may be used to redeem components associated with the accommodation category. In one embodiment, the user defined goals may include preferences or requirements regarding hotel room types, the desired number of hotel rooms, the number of nights for the hotel room; a rental car type, the number of rental cars, the number of days of renting the rental car; any specific brick and mortar store, online shopping store, or company, etc.

In one embodiment, the goals data is analyzed 544 to identify the components and component category in each user defined goal. For example, if a user defined goal includes, for example, a first-class round trip flight to Paris and a five-night stay in Paris at a five-star hotel, in this scenario, the goals analysis engine 444 may identify a round trip flight to Paris as a first component, and a five-night stay at a five-star hotel as a second component of the user defined goal. The user defined goal may be analyzed 544 further to identify component category that is associated with each one or more components that are identified. In the above referenced example, the flight component may be categorized as a travel component category, and the hotel stay component may be categorized as an accommodation category. The goals data may be further analyzed 544 to identify one or more providers that may fulfill one or more components of the user defined goal. For example, if a user defined goal is comprised of a flight to Paris, then the goal may be analyzed 544 to identify all the airline or flight providers that may offer air travel services from the user's preferred starting airport to the appropriate destination airport in or around Paris. Similarly, the goals analysis engine 444 may identify five-star hotel in and around the Paris area if the user defined goal is comprised of five-star accommodation in Paris.

The process may also comprise computing 546 costs for each goal component of the user defined goal. The cost computation 546 may be comprised of identifying a cost associated with fulfilling one or more components of the user defined goal. In one embodiment, costs associated with the one or more components in the user defined goal may be computed 546 in units of reward offerings associated with one or more providers. Units of reward offering generally refers to various units of rewards that may be offered by a rewards provider, such as, but not limited to, reward miles, reward points, reward rebates, etc. For example, if a user defined goal is comprised of a travel component and a hotel stay component, then the goals data may be analyzed to identify the number of reward miles that may be necessary to complete the airline travel, and the number of reward points that may be necessary to redeem towards the hotel stay.

In one embodiment, the cost computation 546 may be performed for each vendor that provides an offering capable of fulfilling a component of the user defined goal. For example, if air travel is a component of a user defined goal, then the goal costs generator may identify every vendor or carrier that may offer flight services from a user's preferred airport to airports in or around a goal destination. Once the appropriate vendors or carriers are identified, costs may be computed 546 for each vendor or carrier in units of reward offerings associated with one or more reward providers.

In one embodiment, variations of individual goals components may be computed 546, where costs can include the cost in points, cash, or a combination of points and cash. As described, variations of goals include options with flights with different airlines, travel class, hotels, tier of hotel, travel dates, etc. In an embodiment, the cost can be normalized to, for example, cost in points using appropriate conversation techniques. Computing costs for variations of individual goals can include determining a cost, e.g., with and without upgrades, a range of traveling dates, hotels, flights, etc.

In one embodiment, wallet data is accessed 550 to obtain accumulated rewards associated with one or more reward accounts that are associated with a user. In the situation accumulated rewards exist, the accumulated rewards can be categorized in a component category and a determination may be made as to whether those rewards are applicable towards component costs identified in the previous step.

If the accumulated rewards can be applied towards component costs identified in the previous step, then the accumulated reward may be deducted 548 from relevant component costs to obtain remaining costs associated with the one or more components in the user defined goal. For example, if a user defined goal is comprised of airline travel, and the user has accumulated some miles that may be applied towards airline travel, then accumulated reward miles may be deducted 548 from the cost of airline travel cost based on applicability rules associated with whether the accumulated rewards may applied for the airline vendor or provider. In a further example, if a user defined goal is comprised of airline travel, and the user has accumulated 10,000 Delta® travel rewards miles, then the accumulated reward miles may be deducted 548 from costs associated with the travelling on a Delta® carrier. However, in one instance, if the Delta® travel rewards are not redeemable towards an American Airlines® flight, then the accumulated reward miles may be not be deducted from the costs associated with the American Airlines® flight. In one embodiment, a table of remaining costs associated with the one or more components in the user defined goal may be output for each vendor wherein rewards may be redeemed to fulfill a component of the user defined goal.

In one embodiment, the process may continue to apply value determination analysis 552 to identify a value score associated with each remaining cost for each vendor associated with each component of the user defined goal. In one embodiment, the value determination engine may be applied 552 to compute a value score associated with each remaining cost associated with each relevant vendor that is associated with each component of the user defined goal. In other words, a value associated with each cost computed in the previous step (step 548) may identified or computed by applying a value determination analysis 552. For example, if, in the previous step, a cost (and/or a reduced cost) is computed for Delta®, Frontier®, and American Airlines® as vendors that are capable of fulfilling a component of a user defined goal, then at step 552 a value associated with each cost computation associated with each carrier/vendor may be computed 552. To put it differently, certain rewards offerings or units may be more valuable than others—step 552 accounts for that. For example, a Delta® rewards mile may be worth two Frontier® reward mile, or vice versa. A variety of different methodologies may be used to compute value, including, but not limited to, referencing an empirical database that may assign a value to a unit of rewards offering based on a currency (such as the US dollar). In other embodiments, an exchange database may be consulted to determine identify the relative value of a unit of reward offering relative to other units of reward offerings. In other embodiments, transfer value data can include transfer costs such as the conversion of reward points from banks or other travel programs such as hotels and other airlines into miles, hotel points, travel points, and/or cash; and any banking costs such as annual fees, interest, etc.

At step 554, appropriate reward offerings may be identified for further downstream analysis. More specifically, step 554 may comprise of identifying reward offerings in the two or more component categories that are in a same transfer family and identifying those transfer families. In one embodiment, the process may identifies 554 reward offerings with lowest value in each component category that are also in the same transfer family, and identify those transfer families. In the above referenced example, wherein a user defined goal is comprised of travel component category and accommodation component category, step 554 may be comprised of identifying value rewards offering associated with each component that are also in the same family. More concretely, if Delta® reward miles and American Airlines® reward miles are identified as offering good value for obtaining the travel component category portion of the user defined goal, and Hilton® reward points and Hyatt® reward points are identified as offering good value for obtaining the accommodation component category portion of the user defined goal, then the transfer value and exchange engine 450 may identify Delta® reward miles and Hilton® reward points if they are part of the same reward family. In this manner, step 554 may be comprised of identifying reward offerings that are both good value to user (based on the above described computation) and also part of the same transfer family. In one embodiment, reward offerings that offer the best (i.e. the lowest value) to the user (based on the above described computation) and are also part of the same transfer family may be identified 554. A variety of different optimization algorithms may be used to compute those offerings in accordance with the description herein.

At step 556 policy data associated with credit card accounts that a user may or may not be associated with. In accordance with this disclosure, step 556 may obtain policy data for card accounts that issue rewards in the same transfer family as the transfer family that is identified in the prior step 554. In other embodiments, credit card accounts that issue rewards in different transfer families may be considered if the value of the rewards that can be obtained from those rewards is greater than the value of rewards that can be obtained from offerings in the same transfer family. In one embodiment, the policy data is comprised of rules regarding the number and type of credit card accounts from one or more providers that a user may be permitted to enroll in.

Referring again to step 550 the user's wallet data may be accessed to obtain credit card account data associated with the user.

The retrieved data may be used to identify new credit cards 558 that the user may be eligible to enroll in based on the obtained policy data at step 556 and the obtained credit card account associated with the user 550. In one embodiment, the new credit card accounts may be identified only if they are in the same transfer families as the ones identified in step 554. More specifically, new credit card accounts may be identified 558 if the user is permitted to sign up for the credit card account based on banking and enrollment rules (e.g., account enrollment rules, credit score requirement, etc.).

At step 560, reward offers associated with one or more credit card accounts may be obtained. More specifically, reward offers may be obtained 560 from the new credit card accounts that are identified in a previous step 558 and/or credit card accounts that are associated with the user as obtained at step 550. In one embodiment, the reward offers from the identified new credit card accounts may be comprised of reward bonuses. The reward bonuses may be earned by at least one of enrolling with a credit card account, remaining enrolled with a credit card account for a period of time, spending a predetermined amount of money with a newly enrolled credit card account, and spending a predetermined amount of money in a predetermined amount of time with a newly enrolled credit card account, number of miles required to travel to specific locations for various flight statuses, accruing a number of points to stay at a hotel for different number of nights and rooms, the conversion or transfer of reward points from banks or other travel programs such as hotels and other airlines into miles or hotel points, and any other appropriate qualifying information, etc.

At step 562 the process may comprise of identifying 562 an optimal wallet recommendation based on user preferences, the optimal wallet recommendation comprising credit card accounts that offer sufficient expected rewards that may be redeemable to purchase the components identified in the user defined goal. In one embodiment, the optimal wallet may be computed based on user preferences, such as the number of credit card accounts that a user would like to have open at any given time. In one embodiment, the optimal wallet may be identified based on transaction spending history associated with the user, which may be accessed via transaction history data 564. For example, if a user is expected to spend $60,000 in the next three months, the optimal wallet of credit card accounts may be comprised of credit card accounts that would enable the user to earn sufficient points—upon spending $60,000—to redeem the points for every component of the user defined goal.

At step 562 the process may comprise of computing timing and spending recommendations for one or more credit card accounts within the optimal set of credit card accounts to meet the user defined goal. In one embodiment, the timing and spending recommendations comprise of a recommendation to enroll for a credit card account at a particular time and/or spending a particular amount of money with a credit card account within a period of time to obtain relevant rewards including bonus rewards. In one embodiment, computed values from a prior step 552, historic spending data from step 564, obtained rewards offers 560 may be used to compute a card sequence. The card sequence can include an order in which to use individual credit card accounts, spending guidelines, account cancelation timeline, replacement card recommendations and the time of cancellation and/or upgrade or downgrade, etc.

Changes to accumulated rewards, banking rules, available credit card accounts, rewards exchange basis, cash exchange basis, and the like can be continuously monitored or monitored per an interval, and compared to an appropriate threshold to evaluate whether costs should be recomputed to determine whether the sequence of changes should be adjusted 562 (e.g., removed or added) in order to help a user reach any specified goals. In the situation a change does not satisfy a change threshold, real-time spending recommendations can be provided 566 and any changes continuously monitored. Real-time spending recommendations can, for example, suggest a credit card, from the cards in the consumer's wallet, to achieve a goal that the user would like to accomplish based on goals data, historic data, policy data, etc. In the situation the change does satisfy a change threshold, the process can proceed to step 546 and updates and reminders can be provided 568. Updates and reminders as described herein can include recommendations on the timing and spending guidelines to help a user stay on track when earning rewards, potential new cards, etc.

In one embodiment, the various elements described above and illustrated in the above referenced figures may be used to provide real-time or near real-time spending recommendations. In one embodiment, the system receives a user defined goal comprising two or more components, wherein each component may be categorized in one or more component categories. It identifies components and component categories associated with the user defined goal, identifies costs associated with the components in the user defined goal, wherein costs are computed in units of reward offerings associated with one or more rewards providers, obtains accumulated rewards associated with one or more reward accounts that are associated with a user, applies the accumulated reward to relevant component costs to obtain remaining costs associated with the one or more components in the user defined goal, applies value determination analysis to identify a value score associated with the one or more remaining costs associated with the one or more components, identifies reward offerings in the two or more component categories that are in a same transfer family and identify those transfer families, obtains policy data associated with one or more credit card accounts that are in the identified transfer families, and obtains credit card account data associated with the user. The system also identifies, based on the obtained policy data and the obtained credit card account associated with the user, new credit card accounts that the user may be eligible for, and obtains reward offers from the identified new credit card accounts and the credit card account data associated with the user. The system also obtains historic spending data associated with the user, identifies an optimal wallet recommendation based on user preferences, the optimal wallet recommendation comprising credit card accounts that offer sufficient expected rewards that are redeemable to purchase the components identified in the user defined goal, the expected rewards computed based on the obtained historic spending data and the obtained rewards offers, computes timing and spending recommendations for one or more credit card accounts within the optimal set of credit card accounts to meet the user defined goal, and presents the computed recommendations to a user device.

In one embodiment, the optimal wallet recommendation may be re-identified in real-time or near real-time based on at least one of the following: newly received costs associated with the components in the user defined goals, newly received accumulated rewards data, newly received value determination data, newly received policy data, newly received transfer family data, and newly received historic spending data. Similarly, in one embodiment, the timing and spending recommendations are re-computed in real-time or near real-time upon receiving at least one of the following: newly received costs associated with the components in the user defined goals, newly received accumulated rewards data, newly received value determination data, newly received policy data, newly received transfer family data, and newly received historic spending data.

In one embodiment, a component of a user defined goal may be comprised of at least one of redemption for air travel, redemption for car rental, redemption for shopping at a particular business or merchant, redemption for cashback, redemption for earning cryptocurrency, redemption for investments, redemption for gifts or gift cards, redemption for charitable contributions, and redemption for green spending, and component category is comprised of at least one of travel category, accommodation category, cashback category, charitable contribution category, return category, investment category, digital currency category and interest rate for transfer balances.

In one embodiment, the costs may be computed for each vendor that provides an offering capable of fulfilling a component of the user defined goal.

In one embodiment, reward offerings may be comprised of at least one of reward points and reward miles.

In accordance with an embodiment of the invention, the value determination analysis may be comprised of determining a value associated with obtaining a unit of reward offering. The value determination analysis maybe comprised of determining a value associated with obtaining a unit of reward offering based on its exchange rate relative to another reward offering, or based on a pre-computed value in a different unit of measure (such as a currency) such that each point or mile of a particular reward offering may be assigned a dollar value based on a variety of different factors.

In one embodiment, the system identifies reward offerings with lowest value in each component category that are also in the same transfer family.

In one embodiment, the policy data may be comprised of rules regarding the number and type of credit card accounts from one or more providers that a user may be permitted to enroll in.

In one embodiment, credit card account data associated with the user may be comprised of credit card and reward accounts that the user is at least one of currently enrolled in or previously enrolled in.

In one embodiment, the reward offers from the identified new credit card accounts are comprised of reward bonuses. The reward bonuses may be earned by at least one of enrolling with a credit card account, remaining enrolled with a credit card account for a period of time, spending a predetermined amount of money with a newly enrolled credit card account, and spending a predetermined amount of money in a predetermined amount of time with a newly enrolled credit card account.

In one embodiment, the historic spending data is comprised of one or more purchase transaction information from at least one financial account associated with the user.

In one embodiment, an optimal set of credit card accounts are identified based on rewards that are likely to accrue to the user if future spending trends are consistent with historical spending data, the optimal set of credit card accounts further identified to accrue sufficient rewards units within a predetermined period of time to be redeemed for the user defined goal.

In one embodiment, the timing and spending recommendations comprise of a recommendation to enroll for a credit card account at a particular time and/or spending a particular amount of money with a credit card account within a period of time to obtain relevant rewards including bonus rewards.

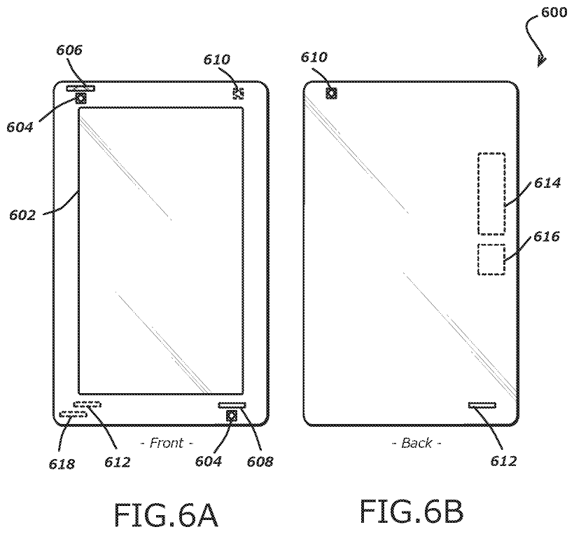

FIG. 6A illustrates a front view of an electronic device and FIG. 6B illustrates a back view of the example electronic computing device 600 that can be used in accordance with various embodiments. Although a portable computing device (e.g., a smartphone, an electronic book reader, or tablet computer) is shown, it should be understood that any device capable of receiving and processing input can be used in accordance with various embodiments discussed herein, where the devices can include, for example, head-mounted displays, notebook computers, personal data assistants, cellular phones, smart glasses or goggles, smartwatch, unmanned vehicles such as drones or other autonomous vehicles, and portable media players, among others.

In this example, the computing device 600 has a display screen 602 (e.g., an LCD element) operable to display information or image content to one or more users or viewers of the device. The display screen of some embodiments displays information to the viewers facing the display screen (e.g., on the same side of the computing device as the display screen). The computing device in this example can include one or more imaging elements, in this example including two image capture elements 604 on the front of the device and at least one image capture element 610 on the back of the device. It should be understood, however, that image capture elements could also, or alternatively, be placed on the sides or corners of the device, and that there can be any appropriate number of capture elements of similar or different types. Each image capture element 604 and 610 may be, for example, a camera, a charge-coupled device (CCD), a motion detection sensor or an infrared sensor, or other image capturing technology.

The device can use the images (e.g., still or video) captured from the imaging elements 604 and 610 to generate a three-dimensional simulation of the surrounding environment (e.g., a virtual reality of the surrounding environment for display on the display element of the device). Further, the device can utilize outputs from at least one of the image capture elements 604 and 610 to assist in determining the location and/or orientation of a user and in recognizing nearby persons, objects, or locations. For example, if the user is holding the device, the captured image information can be analyzed (e.g., using mapping information about a particular area) to determine the approximate location and/or orientation of the user. The captured image information may also be analyzed to recognize nearby persons, objects, or locations (e.g., by matching parameters or elements from the mapping information).

The computing device can also include at least one microphone or other audio capture elements capable of capturing audio data, such as words spoken by a user of the device, music being hummed by a person near the device, or audio being generated by a nearby speaker or other such component, although audio elements are not required in at least some devices. In this example there are three microphones, one microphone 608 on the front side, one microphone 612 on the back, and one microphone 606 on or near a top or side of the device. In some devices there may be only one microphone, while in other devices there might be at least one microphone on each side and/or corner of the device, or in other appropriate locations.

The device 600 in this example also includes one or more orientation- or position-determining elements 618 operable to provide information such as a position data, direction data, motion data, or orientation data for the device. These elements can include, for example, accelerometers, inertial sensors, electronic gyroscopes, and electronic compasses.

The example device also includes at least one communication mechanism 614, such as may include at least one wired or wireless component operable to communicate with one or more electronic devices. The device also includes a power system 616, such as may include a battery operable to be recharged through conventional plug-in approaches, or through other approaches such as capacitive charging through proximity with a power mat or other such device. Various other elements and/or combinations are possible as well within the scope of various embodiments.

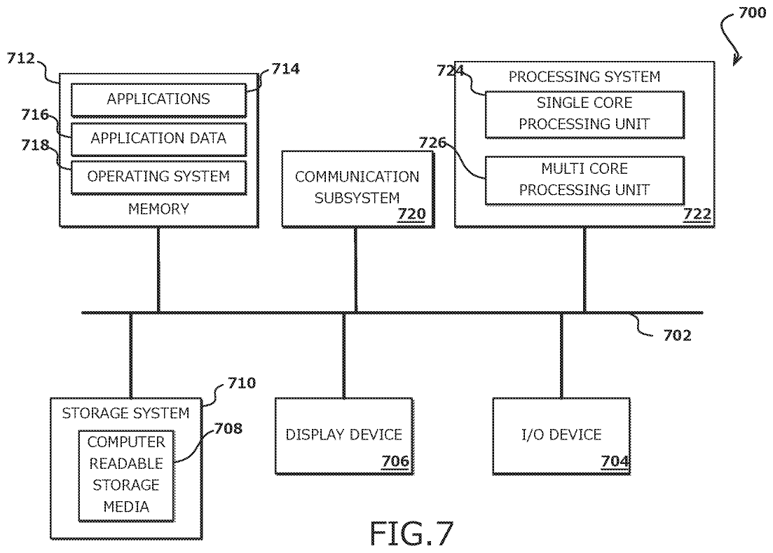

FIG. 7 illustrates a set of basic components of an electronic computing device 700, such as computing device 600 in FIGS. 6A and 6B. In various embodiments, computer device 700 may be used to implement any of the systems, devices, or methods described herein. In some embodiments, computer device 700 may correspond to any of the various devices described herein, including, but not limited, to mobile devices, tablet computing devices, wearable devices, personal or laptop computers, or other devices or systems described herein. As shown in FIG. 7, computer device 700 can include various subsystems connected by a bus 702. The subsystems may include an I/O device subsystem 704, a display device subsystem 706, and a storage subsystem 710 including one or more computer-readable storage media 708. The subsystems may also include a memory subsystem 712, a communication subsystem 720, and a processing subsystem 722.

In device 700, bus 702 facilitates communication between the various subsystems. Although a single bus 702 is shown, alternative bus configurations may also be used. Bus 702 may include any bus or other components to facilitate such communication as is known to one of ordinary skill in the art. Examples of such bus systems may include a local bus, parallel bus, serial bus, bus network, and/or multiple bus systems coordinated by a bus controller. Bus 702 may include one or more buses implementing various standards such as Parallel ATA, serial ATA, Industry Standard Architecture (ISA) bus, Extended ISA (EISA) bus, MicroChannel Architecture (MCA) bus, Peripheral Component Interconnect (PCI) bus, or any other architecture or standard as is known in the art.

In some embodiments, I/O device subsystem 704 may include various input and/or output devices or interfaces for communicating with such devices. Such devices may include, without limitation, a touch screen or other touch-sensitive input device, a keyboard, a mouse, a trackball, a motion sensor or other movement-based gesture recognition device, a scroll wheel, a click wheel, a dial, a button, a switch, audio recognition devices configured to receive voice commands, microphones, image capture based devices such as eye activity monitors configured to recognize commands based on eye movement or blinking, and other types of input devices. I/O device subsystem 704 may also include identification or authentication devices, such as fingerprint scanners, voiceprint scanners, iris scanners, or other biometric sensors or detectors. In various embodiments, I/O device subsystem may include audio output devices, such as speakers, media players, or other output devices.

Computer device 700 may include a display device subsystem 706. Display device subsystem may include one or more lights, such as one or more light emitting diodes (LEDs), LED arrays, a liquid crystal display (LCD) or plasma display or other flat-screen display, a touch screen, a head-mounted display or other wearable display device, a projection device, a cathode ray tube (CRT), and any other display technology configured to visually convey information. In various embodiments, display device subsystem 706 may include a controller and/or interface for controlling and/or communicating with an external display, such as any of the above-mentioned display technologies.

As shown in FIG. 7, device 700 may include storage subsystem 710 including various computer-readable storage media 708, such as hard disk drives, solid-state drives (including RAM-based and/or flash-based SSDs), or other storage devices. In various embodiments, computer-readable storage media 708 can be configured to store software, including programs, code, or other instructions, that is executable by a processor to provide the functionality described herein. For example, the instructions, when executed, can enable a computing device to maximize rewards associated with financial accounts for at least one user-defined goal or reward criterion (e.g., a travel benefit, a cashback benefit, a flight benefit, a hotel benefit, a charitable contribution benefit, a return benefit, etc.) in accordance with the present disclosure may be embodied on a computer-readable medium.

In some embodiments, storage system 710 may include various datastores or repositories or interface with various datastores or repositories that store data used with embodiments described herein. Such datastores may include, databases, object storage systems and services, data lakes or other data warehouse services or systems, distributed datastores, cloud-based storage systems and services, file systems, and any other data storage system or service. In some embodiments, storage system 710 can include a media reader, card reader, or other storage interfaces to communicate with one or more external and/or removable storage devices. In various embodiments, computer-readable storage media 708 can include any appropriate storage medium or combination of storage media. For example, computer-readable storage media 708 can include, but is not limited to, any one or more of random-access memory (RAM), read-only memory (ROM), electronically erasable programmable ROM (EEPROM), flash memory or other memory technology, optical storage (e.g., CD-ROM, digital versatile disk (DVD), Blu-ray® disk or other optical storage device), magnetic storage (e.g., tape drives, cassettes, magnetic disk storage or other magnetic storage devices). In some embodiments, computer-readable storage media can include data signals or any other medium through which data can be transmitted and/or received.

Memory subsystem 712 can include various types of memory, including RAM, ROM, flash memory, or other memory. Memory 712 can include SRAM (static RAM) or DRAM (dynamic RAM). In some embodiments, memory 712 can include a BIOS (basic input/output system) or other firmware configured to manage initialization of various components during, e.g., startup. As shown in FIG. 7, memory 712 can include applications 714 and application data 716. Applications 714 may include programs, code, or other instructions, that can be executed by a processor. Applications 714 can include various applications such as browser clients, campaign management applications, data management applications, and any other application. Application data 716 can include any data produced and/or consumed by applications 714. Memory 712 can additionally include operating system 718, such as macOS®, Windows®, Linux®, various UNIX® or UNIX- or Linux-based operating systems, or other operating systems.

Device 700 can also include a communication subsystem 720 configured to facilitate communication between device 700 and various external computer systems and/or networks (such as the Internet, a local area network (LAN), a wide area network (WAN), a mobile network, or any other network). Communication subsystem 720 can include hardware and/or software to enable communication over various wired (such as Ethernet or other wired communication technology) or wireless communication channels, such as radio transceivers to facilitate communication over wireless networks, mobile or cellular voice and/or data networks, WiFi networks, or other wireless communication networks. Additionally, or alternatively, communication subsystem 720 can include hardware and/or software components to communicate with satellite-based or ground-based location services, such as GPS (global positioning system). In some embodiments, communication subsystem 720 may include, or interface with, various hardware or software sensors. The sensors may be configured to provide continuous or and/or periodic data or data streams to a computer system through communication subsystem 720

As shown in FIG. 7, processing system 722 can include one or more processors or other devices operable to control computing device 700. Such processors can include single-core processors 724, multi-core processors, which can include central processing units (CPUs), graphical processing units (GPUs), application specific integrated circuits (ASICs), digital signal processors (DSPs) or any other generalized or specialized microprocessor or integrated circuit. Various processors within processing system 722, such as processors 724 and 726, may be used independently or in combination depending on the application.

Various other configurations are may also be used, with particular elements that are depicted as being implemented in hardware may instead be implemented in software, firmware, or a combination thereof. One of ordinary skill in the art will recognize various alternatives to the specific embodiments described herein.

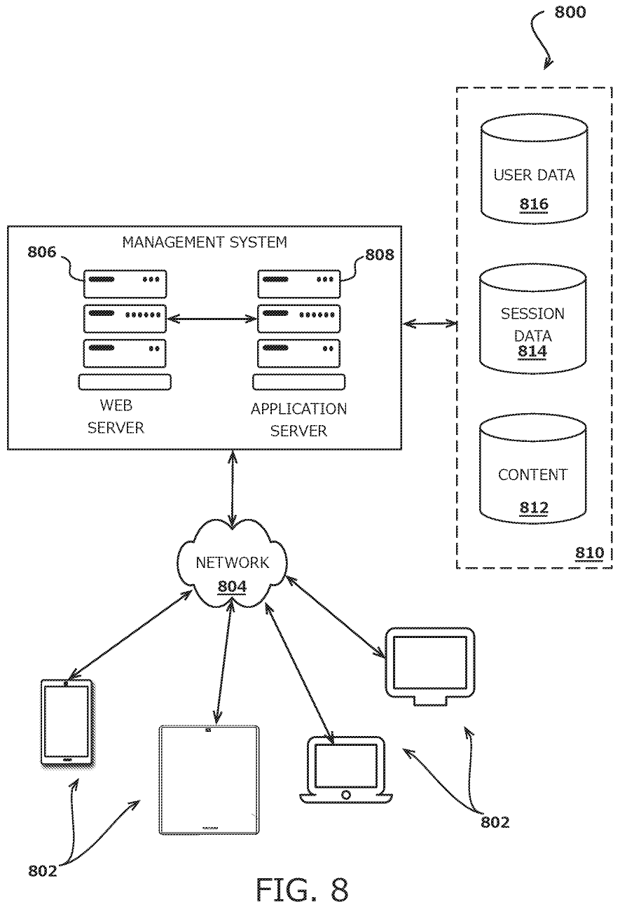

FIG. 8 illustrates an example of an environment 800 for implementing aspects in accordance with various embodiments. As will be appreciated, although a Web-based environment is used for purposes of explanation, different environments may be used, as appropriate, to implement various embodiments. The environment includes electronic client devices 802, which can include any appropriate device operable to send and receive requests, messages, or information over an appropriate network 804 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections, and combinations thereof. In this example, the network includes the Internet, as the environment includes a Web server 806 for receiving requests and serving content in response thereto, although for other networks an alternative device serving a similar purpose could be used as would be apparent to one of ordinary skill in the art.

The illustrative environment includes at least one application server 808 and a datastore 810. It should be understood that there can be several application servers, layers or other elements, processes or components, which may be chained or otherwise configured, which can interact to perform tasks such as obtaining data from an appropriate datastore. As used herein, the term “datastore” refers to any device or combination of devices capable of storing, accessing and retrieving data, which may include any combination and number of data servers, databases, data storage devices and data storage media, in any standard, distributed or clustered environment. The application server 808 can include any appropriate hardware and software for integrating with the datastore 810 as needed to execute aspects of one or more applications for the client device and handling a majority of the data access and business logic for an application. The application server provides access control services in cooperation with the datastore and can generate content such as text, graphics, audio and/or video to be transferred to the user, which may be served to the user by the Web server 806 in the form of HTML, XML or another appropriate structured language in this example. The handling of all requests and responses, as well as the delivery of content between the client device 802 and the application server 808, can be handled by the Web server 806. It should be understood that the Web and application servers are not required and are merely example components, as structured code discussed herein can be executed on any appropriate device or host machine as discussed elsewhere herein.

The datastore 810 can include several separate data tables, databases or other data storage mechanisms and media for storing data relating to a particular aspect. For example, the datastore illustrated includes mechanisms for storing content (e.g., production data) 812 and user information 816, which can be used to serve content for the production side. The datastore is also shown to include a mechanism for storing log or session data 814. It should be understood that there can be many other aspects that may need to be stored in the datastore, such as page image information and access rights information, which can be stored in any of the above listed mechanisms as appropriate or in additional mechanisms in the datastore 810. The datastore 810 is operable, through logic associated therewith, to receive instructions from the application server 808 and obtain, update or otherwise process data in response thereto.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the environment 800 in FIG. 8 should be taken as being illustrative in nature and not limiting to the scope of the disclosure.

An environment such as that illustrated in FIG. 8 can be useful for a provider such as an on-demand mixed-reality provider who wishes to enable data capture for use in on-demand mixed-reality experiences (e.g., a live event service, a shopping service, etc.). The provider can utilize a collaborative data capture service which can coordinate the capture of content, generate and present for display mixed-reality experiences from the captured content, connect users (e.g., virtual travelers or virtual participants, or requestors) to providers (e.g., on-demand providers), facilitate payment between requestors and providers, facilitate content licensing between license holders and providers, streamline copyright use, etc.

The various embodiments can be implemented in a wide variety of operating environments, which in some cases can include one or more user computers or computing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, FTP, UPnP, NFS, and CIFS. The network can be, for example, a local area network, a wide-area network, a virtual private network, the internet, an intranet, an extranet, a public switched telephone network, an infrared network, a wireless network and any combination thereof.

In embodiments utilizing a web server, the web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM®.

The environment can include a variety of datastores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random-access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or web browser. It should be appreciated that alternate embodiments may have numerous variations from that described above. For example, customized hardware might also be used, and/or particular elements might be implemented in hardware, software (including portable software, such as applets) or both. Further, connection to other computing devices such as network input/output devices may be employed.

Storage media and other non-transitory computer-readable media for containing code, or portions of code, can include any appropriate media known or used in the art, including storage media and communication media, such as but not limited to volatile and non-volatile, removable and non-removable media implemented in any method or technology for storage of information such as computer-readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

The methods, systems, and devices discussed above are described with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the above description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Having been provided with the description and illustration of the present application, one skilled in the art may envision variations, modifications, and alternate embodiments falling within the general inventive concept discussed in this application that do not depart from the scope of the following claims.

1. A computing system, comprising:
a computing device processor; and
memory including instructions that, when executed by the computing device processor, enable the computing system to:
receive a request at the computing system, the request for an optimal wallet recommendation that includes timing recommendations and spending recommendations, the request being associated with a user defined multiple redemption component goal comprising two or more redemption components, wherein each redemption component is categorized in a different redemption component category;
analyze the request to identify the two or more redemption components associated with the user defined multiple redemption component goal;
identify costs associated with the two or more redemption components in the user defined multiple redemption component goal, wherein the costs are computed in units of reward offerings associated with one or more rewards providers;
obtain accumulated rewards associated with one or more reward accounts that are associated with a user via a network in real-time by scanning a first application programming interface (API) associated with a first network resource associated with the one or more reward providers;
apply the accumulated rewards to relevant component costs to obtain remaining costs associated with the two or more redemption components in the user defined multiple redemption component goal;
apply value determination analysis to identify a value score associated with the two or more remaining costs associated with the two or more redemption components;
identify reward offerings in the two or more redemption component categories that are in a same transfer family and identify those transfer families;
obtain policy data associated with one or more credit card accounts that are in the identified transfer families via the network in real-time by scanning a second API associated with a second network resource associated with one or more credit card providers providing the one or more credit card accounts;
obtain credit card account data associated with the user via the network in real-time by scanning the second API associated with the second network resource;
identify, based on the obtained policy data and the obtained credit card account associated with the user, new credit card accounts that the user may be eligible for;
obtain bonus reward offers from the identified new credit card accounts and the credit card account data associated with the user from the second network resource via the network in real-time by scanning the API, individual bonus reward offers associated with an amount to spend within a time period to receive the bonus reward offer;
obtain historic spending data associated with the user via the network in real-time by scanning the second API associated with the second network resource;
generate the optimal wallet recommendation based on user preferences, the optimal wallet recommendation comprising a combination of at least one current credit card account associated with the user and new credit card accounts that offer sufficient expected rewards that are redeemable to purchase the two or more redemption components identified in the user defined multiple redemption component goal, the expected rewards computed based on the obtained historic spending data and the obtained bonus rewards offers;
determine the timing recommendations and the spending recommendations to satisfy the two or more redemption components of the multiple redemption component goal, the timing recommendations corresponding to an order in which to use individual credit card accounts within the optimal wallet recommendation to meet the user defined multiple redemption component, the spending recommendations corresponding to an amount to spend using the individual credit card accounts within the optimal wallet recommendation to meet the user defined multiple redemption component goal; and
generating a user interface comprising the optimal wallet recommendation, the timing recommendations, and the spending recommendations.

2. The computing system of claim 1, wherein the optimal wallet recommendation is re-identified in near real-time based on at least one of the following: newly received costs associated with the two or more redemption components in the user defined multiple redemption component goal, newly received accumulated rewards data, newly received value determination data, newly received policy data, newly received transfer family data, and newly received historic spending data.

3. The computing system of claim 1, wherein the timing and spending recommendations are re-computed in near real-time upon receiving at least one of the following: newly received costs associated with the two or more redemption components in the user defined multiple redemption component goal, newly received accumulated rewards data, newly received value determination data, newly received policy data, newly received transfer family data, and newly received historic spending data.

4. The computing system of claim 1, wherein a redemption component is comprised of at least one of redemption for air travel, redemption for car rental, redemption for shopping at a particular business or merchant, redemption for cashback, redemption for earning cryptocurrency, redemption for investments, redemption for gifts or gift cards, redemption for charitable contributions, and redemption for green spending, and a redemption component category is comprised of at least one of travel category, accommodation category, cashback category, charitable contribution category, return category, investment category, digital currency category, and interest rate category for transfer balances.

5. The computing system of claim 1, wherein the costs are computed for each vendor that provides an offering capable of fulfilling a redemption component of the user defined multiple redemption component goal.

6. The computing system of claim 1, wherein the reward offerings are comprised of at least one of reward points and reward miles.

7. The computing system of claim 1, wherein the value determination analysis is comprised of determining a value associated with obtaining a unit of reward offering.

8. The computing system of claim 1, wherein the value determination analysis is comprised of determining a value associated with obtaining a unit of reward offering based on its exchange rate relative to another reward offering.

9. The computing system of claim 1, wherein the instructions, when executed by the computing device further enables the computing system to identify reward offerings with lowest value in each redemption component category that are also in the same transfer family.

10. The computing system of claim 1, wherein the policy data is comprised of rules regarding a number of credit card accounts and a type of credit card accounts from one or more providers that a user may be permitted to enroll in.

11. The computing system of claim 1, wherein the credit card account data associated with the user is comprised of credit card and reward accounts that the user is at least one of currently enrolled in or previously enrolled in.

12. The computing system of claim 1, wherein the reward offers from the identified new credit card accounts are comprised of reward bonuses.

13. The computing system of claim 12, wherein the reward bonuses may be earned by at least one of enrolling with a credit card account, remaining enrolled with a credit card account for a period of time, spending a predetermined amount of money with a newly enrolled credit card account, and spending a predetermined amount of money in a predetermined amount of time with a newly enrolled credit card account.

14. The computing system of claim 1, wherein the historic spending data is comprised of one or more purchase transaction information from at least one financial account associated with the user.

15. The computing system of claim 1, wherein the at least one current credit card account and the new credit card accounts associated with the optimal wallet recommendation are identified based on rewards that are likely to accrue to the user if future spending trends are consistent with historical spending data, the combination of current credit card accounts and new credit card accounts further identified to accrue sufficient rewards units within a predetermined period of time to be redeemed for the user defined goal.

16. The computing system of claim 1, wherein the timing and spending recommendations comprise of a recommendation to enroll for a credit card account at a particular time and/or spending a particular amount of money with a credit card account within a period of time to obtain relevant rewards including bonus rewards.

17.-20. (canceled)
